(19) United States
(12) Patent Application Publication
(10) Pub. No.: US 2014/0258356 A1
(43) Pub. Date: Sep. 11, 2014

(54) COLUMN AND CONSTRAINT GENERATION METHOD FOR OPTIMAL STRATEGIES

(71) Applicant: University of South Florida, Tampa, FL (US)

(72) Inventors: Bo Zeng, Tampa, FL (US); Long Zhao, Tampa, FL (US)

(73) Assignee: University of South Florida, Tampa, FL (US)

(21) Appl. No.: 14/106,081

(22) Filed: Dec. 13, 2013

Related U.S. Application Data
(60) Provisional application No. 61/736,984, filed on Dec. 13, 2012.

(51) Int. Cl. G06F 17/11

(52) U.S. Cl. CPC G06F 17/11
USPC 708/446

(57) ABSTRACT

Optimization processes, which are parameter driven for solving interdiction problems, for example, power grid interdiction problems, are provided. An algorithm of the subject invention can include column-and-constraint generation and can be used to solve a set of system interdiction, vulnerability analysis, and reliability based design problems, including a power grid vulnerability analysis problem and an edge-interdiction minimum dominating set problem. An algorithm can be provided on a computer-readable medium, a computer, a portable computing device, or other machine.

### CROSS-REFERENCE TO RELATED APPLICATION

This application claims the benefit of U.S. Provisional Application Ser. No. 61/736,984, filed Dec. 13, 2012, which is hereby incorporated by reference in its entirety.

### BACKGROUND OF THE INVENTION

Power grid vulnerability is a major concern. Algorithms are widely used in power grid contingency analysis and security studies. Efficient algorithms are highly demanded to solve problems of realistic size. Such algorithms can sometimes be used to solve other interdiction problems.

### BRIEF SUMMARY OF THE INVENTION

Embodiments of the subject invention are drawn to algorithms for solving interdiction problems, such as edge-interdiction problems. For example, an algorithm can be used to solve an edge-interdiction minimum dominating set problem.

Embodiments of the subject invention are also drawn to computer-readable media (e.g., non-transitory media), computers, portable computing devices, and other machines including an algorithm as described herein.

Additional embodiments of the subject invention are drawn to efficient algorithms to solve a leader-follower problem. The follower can have discrete (e.g., binary) decisions. A master bi-level problem that gradually creates and includes the follower's continuous variables for an identified critical discrete (e.g., binary) decision can be solved. For a min-max problem, the augmented master problem can provide a lower bound and any leader-follower decision can provide an upper bound. When these two bounds match, an optimal solution, which is the leader's decision, is obtained. The solution method has several applications, including in military, security, and information technology industries. It can provide optimal decision support for defender-attacker or attacker-defender applications, critical infrastructure systems protection, sensor placement, and network system reliability analysis.

Embodiments of the subject invention can model transmission line switching operations using binary decision variables in the third level, i.e. the Optimal Power Flow (OPF) model, to obtain a novel defend-attack-defend model. This formulation enables, for example, power grid operators to be able to switch off transmission lines to mitigate damage if an outage/attack happens on a power grid. A nested column-and-constraint generation (C&CG) can be implemented to solve the problem to the global optimality.

### BRIEF DESCRIPTION OF THE DRAWINGS

FIG. 1 shows an interdiction graph.

FIG. 2 shows a graph of performance of different trials of Benders decomposition.

FIG. 3 shows graph of results of implementation of an algorithm according to an embodiment of the subject invention.

FIG. 4 shows a schematic of an IEEE one-area RTS-96 system.

FIG. 5 shows a schematic of an IEEE three-area RTS-96 system.

FIG. 6 shows a schematic of an IEEE one-area RTS-96 system.

FIG. 7 shows a flow chart of an algorithm according to an embodiment of the subject invention.

FIG. 8 shows load sheds of a system according to an embodiment of the subject invention.

FIG. 9 shows a graph of average load shed under different attacks according to an embodiment of the subject invention.

FIG. 10 shows a graph of load shed reductions according to an embodiment of the subject invention.

FIG. 11 shows a schematic of a 7-bus power system.

### DETAILED DISCLOSURE OF THE INVENTION

Embodiments of the subject invention are drawn to algorithms for solving interdiction problems, such as edge-interdiction problems. For example, an algorithm can be used to solve an edge-interdiction minimum dominating set problem.

Embodiments of the subject invention are also drawn to computer-readable media (e.g., non-transitory media), computers, portable computing devices, and other machines including an algorithm as described herein.

Embodiments of the subject invention are also drawn to efficient algorithms to solve a leader-follower problem. The follower can have discrete (e.g., binary) decisions. A master bi-level problem that gradually creates and includes the follower's continuous variables for an identified critical discrete (e.g., binary) decision can be solved. For a min-max problem, the augmented master problem can provide a lower bound and any leader-follower decision can provide an upper bound. When these two bounds match, an optimal solution, which is the leader's decision, is obtained. The solution method has several applications, including in military, security, and information technology industries. It can provide optimal decision support for defender-attacker or attacker-defender applications, critical infrastructure systems protection, sensor placement, and network system reliability analysis.

Embodiments of the subject invention can model transmission line switching operations using binary decision variables in the third level, i.e. the Optimal Power Flow (OPF) model, to obtain a novel defend-attack-defend model. This formulation enables, for example, power grid operators to be able to switch off transmission lines to mitigate damage if an outage/attack happens on a power grid. A nested column-and-constraint generation (C&CG) can be implemented to solve the problem to the global optimality.

In certain embodiments, the operations of transmission line switching in contingencies can be modeled, and a defend-attack-defend problem with transmission line switching can be formulated. Power grid vulnerability and the advantage from line switching can be quantitatively analyzed.

For an undirected graph G=(V,E), finding a minimum dominating set (MDS) is a known NP-complete problem. An edge interdiction MDS problem has been proposed, in which an attacker, who has an amount of resources, tries to remove several edges (with associated attacking costs) in order to increase the resulted cardinality of the minimum dominating set.

An edge interdiction MDS (EI-MDS) problem can be formulated as the following integer bi-level program with positive rational coefficients. Edge interdiction is defined as yᵢⱼ=1 if edge (i,j)εE is removed by the attacker, and yᵢⱼ=0 otherwise. Constraint (3) restricts the total budget of attacks with the cost of attacking edge (i, j)εE. Multiple edges are treated as different lines. In simple graphs, the loop (1-cycle) can be ignored in an MDS problem and the multiple edges between two vertices can be aggregated as a single edge with a combination of attacking costs. However, many embodiments of the subject invention can be applied without modification to the graph with loops and multiple edges.

$$\begin{matrix}[ EI \text{-} MDS ] & \\ {γ}_{B}^{E} ( G ) = {max}_{y} {min}_{x} {\sum }_{{v}_{i} ∈ V} {x}_{i} & ( 1 ) \\ s . t . {x}_{i} + {\sum }_{j \text{:} ( {v}_{i} , {v}_{j} ) ∈ E} ( 1 - {y}_{ij} ) {x}_{j} \geq 1 , ∀ {v}_{i} ∈ V & ( 2 ) \\ {\sum }_{( {v}_{i} , {v}_{j} ) ∈ E} {c}_{ij} {y}_{ij} \leq B & ( 3 ) \\ {x}_{i} ∈ \{ 0 , 1 \} , ∀ {v}_{i} ∈ V & ( 4 ) \\ {y}_{ij} ∈ \{ 0 , 1 \} , ∀ ( {v}_{i} , {v}_{j } ) ∈ E . & ( 5 )\end{matrix}$$

Let S be the set of edges in G corresponding to a feasible attack, and Proposition 1 follows as an observation.

PROPOSTION 1. If D⊂V is a minimum dominating set of G−S, then it is a dominating set of G.

A result can be generalized, and Lemma 1 can be stated.

LEMMA 1. The problem EI-MDS has an upper bound r(G)+L, where L=max{Σ₍ᵥ_{ᵢ}_{,v}_{ⱼ}_{)εE}yᵢⱼ:Σ₍ᵥ_{ᵢ}_{,v}_{ⱼ}_{)εE}cᵢⱼyᵢⱼ≦B,yᵢⱼε{0,1}, ∀(vᵢ,vⱼ)εE}.

In order to prove Lemma 1, suppose that V̂ is a minimum dominating set of G, i.e., |V̂|=γ(G). It is claimed that a dominating set V* with |V*|≦γ(G)+1 exists if one edge is removed from G. Indeed, assume that the edge (vₚ, v_{q})εE is interdicted, then V*=V̂ remains a dominating set if vₚ, v_{q}εV̂ or vₚ, v_{q}εV̂. If only one of the two endpoints is in a dominating set, e.g., vₚεV̂, then V*=V̂U {v_{g}} is a dominating set of G−{(vₚ, v_{q})}. In all cases, |V*|≦γ(G)+1. Since the lower level is a minimization problem, γ(G)+1 is a valid upper bound for an MDS problem with respect to G−{(vₚ, v_{q})}. Then, the conclusion follows because any feasible attack can be constructed by selecting interdicted edges one by one.

In the case that all interdiction costs are unit, i.e., c_{if}=1, and w.l.o.g., BεZ⁺ namely the regular-edge interdiction minimum dominating set (REI-MDS) problem, the following corollary follows from L=B for an REI-MDS problem in Lemma 1.

Corollary 1. γ(G)+B is an upper bound for an REI-MDS problem.

The above lemma and corollary are significant in the sense that the quality of any feasible interdiction decision can be justified with upper bound information. For example, given a feasible attack S, γ(G−S) corresponds to a lower bound of the bi-level [EI-MDS] problem. If γ(G−S)=r(G)+L, it can be claimed that S is an optimal interdiction for upper-level decision makers because LB=UB implies optimality. In fact, if all interdiction cost are unit, an improved upper bound could result if the optimal objective value with respect to a smaller budget is known.

COROLLARY2. Let B₁,B₂ε [symbol] and B₁≦B₂. For REI-MDS problem, γ^{K}_{B}_{₂}(G−S)≦γ^{K}_{B}_{₂}(G−S)+(B₂−B₁).

The argument for Corollary 2 is similar to that for Lemma 1. The relationship between optimal solutions for B₁ and B₂, when B₂−B₁=1, can be characterized. For convention, it can be assumed that B₁=B and B₂=B+1≦|E|. For convention, it is said that eεS is reductant if γ(G−S)=γ(G−S+{e}).

PROPOSITION 2. (i) IF REI-MDS problem with budget B+1 has an optimal solution S* with a reductional edge eεS*, then γ{{(G−S)=γ}}^{K}_{B+1}(G−S). In addition, S*−{e} is an optimal solution for the problem with budget B. (ii) If all the optimal solutions S₁, S₂, . . . , Sₙ for budget B+1 do not contain a reductant edge, then γ{{(G−S)=γ}}^{K}_{B+1}(G−S)−1. Moreover, ∀i=1, 2, . . . n, Sᵢ={e} where ∀eεSᵢ is an optimal solution for the problem with budget B.

The second part of Proposition 2 can be of theoretical interests, because all the optimal solutions need to be enumerated; otherwise it is inconclusive. An embodiment of the subject invention can lead to at least two or exactly two exact solution approaches to solve EI-MDS or REI-MDS problems. For convention, let Y⊂{0, 1}^{|E|} denote the set of all interdiction decisions satisfying the budget constraint. Also, let V(x) be the dominating set with respect to a lower-level solution x, let E(y) be the set of all edges that are interdicted in yεY, and let E⁻¹(S)εY be such that yₑ=1 if eεS and yₑ=0 otherwise for all eεE.

In an embodiment, it can be assumed that D⊂V is a dominating set of G. For a nε D̅, let Fₙ(D)={(u, v):∀vεD}. Clearly |{Fₙ(D):∀uε D̅}|=| D̅|. Suppose Dₙ, n=1, 2, . . . m, are Dₙ is not a dominating set of G−E(w) for any n=1, 2, . . . , m. Now we present the kernel theorem which leads to the pure discrete approach.

THEOREM 1. Let y¹, y², . . . , y^{m} be edge interdictions and x¹, x², . . . , x^{m} the corresponding optimal lower-level solutions. If for any yεY\{y¹, y², . . . y^{m}}, y is not n infeasible edge interdiction of {V(x¹, V(x²), . . . , V(x^{m})}, then the optimal solution y^{x}=y^{k}, where kε{1, 2, . . . , m} and ∥x^{k}∥=max {∥x¹∥₁, ∥x²∥₁, . . . , ∥x^{m}∥₁}.

In order to prove Theorem 1, let Obj* denote the optimal objective value. Since any feasible edge interdiction provides a lower bound, we have Obj*≧max{∥x¹∥₁, ∥x²∥₁, . . . , ∥x^{m}∥₁}. On the other hand, max{∥x¹∥₁, ∥x²∥₁, . . . , ∥x^{m}∥₁} is a valid upper bound for all yεY. Indeed, if yε{y¹, y², . . . , y^{m}}, then the statement holds naturally. If yεY\{y¹, y², . . . , y^{m}}, then there exists a set, e.g., x^{j}ε{x¹, x², . . . , x^{m}}, that is a dominating set for this y, therefore ∥x^{k}∥=max{∥x¹∥₁, ∥x²∥₁, . . . , ∥x^{m}∥₁}≧∥x^{j}∥₁ is a uniformly upper bound of the optimal objective value for all yεY\{y¹, y², . . . , y^{m}}. Since max{∥x¹∥₁, ∥x²∥₁, ∥x^{m}∥₁}≧Obj*≧max{∥x¹∥₁, ∥x²∥₁, ∥x^{m}∥₁}, the equality will go through, which indicates that y*=y^{k} is an optimal solution to EI-MDS.

The above theorem has algorithmic consequence as well. For convention, y* and η can be used to record the current best interdiction decision and corresponding worst case objective value. Thus, in an embodiment of the subject invention, an algorithm can be presented in the following steps.
Step 1. Pick up an arbitrary y¹εY, set η=0 and k=1. Go to Step 2.
Step 2. Solve MDS problem for the given y^{k}, denote the solution by x^{k}. If ∥x^{k∥}₁≧ηupdate y*=y^{k} and η=∥x^{k}∥₁. Go to Step 3.
Step 3. If there exists an infeasible edge interdiction, set w⊂Y of (Dⁿ)ₙ₌₁^{k} in G, where Dₙ=V(xⁿ), then let k=k+1, y^{k}=w and go to Step 2. Otherwise, the algorithm stops.

The above algorithm is finitely convergent and can find the global optimal solution as proven in Theorem 1. To find an infeasible edge interdiction in Step 3, if it exists, is critical. In fact, any feasible solution to the following system can be the desired set w in iteration k, and no such a w exists if the system is unsolvable:

$$P = \{ \begin{matrix}{\sum }_{( {v}_{i} , {v}_{j} ) ∈ E} {c}_{ij} {y}_{ij} \leq B , \\ {\sum }_{u ∈ {\overline{D}}_{q}} {\prod }_{e = {F}_{u} ( {D}_{q} )} {y}_{e} \geq 1 , ∀ q = 1 , 2 , … , k \\ {y}_{e} ∈ \{ 0 , 1 \} , ∀ e ∈ E .\end{matrix} \}$$

For any q=1, 2, . . . , k, the second inequality cannot be linearized in a straightforward manner. In fact, it is easier than traditional linearization of products of binary variables in integer programming, as shown in Example 1 below.

In many embodiments, any feasible attack provides a lower bound of the optimal objective value, and Lemma 1 gives an upper bound. However, the quality of the upper bound may be unknown. Therefore, an improved upper bound can be critical in the sense that it may close the gap and even confirm optimality, i.e., an early termination in implementation.

In an embodiment, an improved upper bound can evolve iteratively and lead to a computationally-effective global optimality condition.

Theorem 2. Let y¹, y², . . . , y^{m} and x¹, x², . . . x^{m} be defined as in Theorem 1. Let T be a positive integer, and D₀ be the minimum dominating set of G. If the following system is unsolvable,

$${P}^{′} = \{ \begin{matrix}{\sum }_{u ∈ \overline{{D}_{0}}} {\prod }_{e ∈ {F}_{u} ( {D}_{0} )} {y}_{e} \geq T \\ {\sum }_{( {v}_{i} , {v}_{j} ) ∈ E} {c}_{ij} {y}_{ij} \leq B , \\ {\sum }_{u ∈ {\overline{D}}_{q}} {\prod }_{e ∈ {F}_{u} ( {D}_{q} )} {y}_{e} \geq 1 , ∀ q = 1 , 2 , … , m \\ {y}_{e} ∈ \{ 0 , 1 \} , ∀ e ∈ E ,\end{matrix} \}$$

then max{γ(G)+T−1, max{∥x¹∥₁, ∥x²∥₁, . . . , ∥x^{m}∥₁}} is a valid upper bound for an EI-MDS problem.

In order to prove this theorem, for any feasible attack yεY, at least one of the following two cases must be true since the above system P′ is unsolvable.

Case I. The first constraint in P′ is violated for any yεY. This implies removing T−1 vertices in D̅₀̅ to D₀ is sufficient to make updated D₀ is a dominating set of interdiction y. Therefore, γ(G)+T−1 is a valid upper bound.

Case II. At least one of the constraints for q=1, 2, . . . , m in P′ is violated for any yεY. This implies we can find one set from {D₁, D₂, . . . , Dₘ} which is a dominating set for any feasible attack. Therefore max {∥¹∥₁, ∥x²∥₁, . . . , ∥x^{m}∥₁} is a valid upper bound.

The conclusion follows consequently.

Proposition 3 also follows based on Theorem 2.

Proposition 3. If T=max {∥x¹∥₁, ∥x²∥₁, . . . , ∥x^{m}∥₁}−γ(G)+1 in Theorem 2, then algorithm stops and the optimal solution is y*=y^{k}, where kε{1, 2, . . . , m} and ∥x^{k}∥=max{∥x¹∥₁, ∥x²∥₁, . . . , ∥x^{m}∥₁}.

In the pure integer approach discussed above, an infeasible interdiction of the known dominating sets can be pursued. However, there is no penalty for the new interdiction decision, i.e., as long as it can make all the known dominating sets infeasible, its quality with respect to the objective value is not considered. In other words, the search direction can be considered mild. In an embodiment, a mixed-integer approach can be used. A mixed-integer approach can guarantee or make very likely the deepest search direction for finding the new interdiction decision.

Theorem 3. EI-MDS is equivalent to the following problem:

$$\begin{matrix}[ ( Extend ) EI \text{-} MDS ] & \\ {γ}_{B}^{E} ( G ) = {max}_{y} {min}_{x , z} {\sum }_{{v}_{i} ∈ V} ( {x}_{i} + {z}_{i} ) & ( 6 ) \\ s . t . {x}_{i} + {\sum }_{j \text{:} ( {v}_{i} , {v}_{j} ) ∈ E} ( 1 - {y}_{ij} ) {x}_{j} + {z}_{i} \geq 1 , ∀ {v}_{i} ∈ V & ( 7 ) \\ {\sum }_{( {v}_{i} , {v}_{j} ) ∈ E} {c}_{ij} {y}_{ij} \leq B & ( 8 ) \\ {x}_{i} ∈ \{ 0 , 1 \} , {z}_{i} \geq 0 , ∀ {v}_{i} ∈ V & ( 9 ) \\ {y}_{ij} ∈ \{ 0 , 1 \} , ∀ ( {v}_{i} , {v}_{j} ) ∈ E & ( 10 )\end{matrix}$$

In order to prove Theorem 3, it can be claimed that yεY, there exists an optimal solution for the lower level problem such that zᵢ=0, ∀vᵢεV. Then the conclusion follows. To this end, the following facts can be shown in one of the optimal solutions for the lower level problem. (i) zᵢ<=1, ∀vᵢεV. If zᵢ>1 for some i in any solution, the value of this zᵢ can be reduced to 1 which leads to a lower objective value while maintaining the feasibility of all constraints. (ii) zᵢε{0, 1}, ∀vᵢεV, i.e., zᵢ cannot be a fractional value. If 0<zᵢ<1 for some i, since xᵢε{0, 1} ∀vᵢεV, we have xᵢ+Σj:(v_{ᵢ}_{,v}_{ⱼ}_{)εE}(1−yᵢⱼ)xⱼ≧1 for any i with 0<zᵢ<1. Therefore, zᵢ can be reduced to 1, which again leads to a lower objective value and maintains the feasibility of all constraints. (iii) If z₁=1 for some i, we know that xᵢ+Σ_{i:(v}_{ᵢ}_{,v}_{ⱼ}_{)εE}(1=yᵢⱼ)xⱼ=0: for this I; otherwise, zᵢ can be reduced to 0 to obtain a lower objective value. Therefore, a different optimal solution can be constructed with xᵢ=1 and zᵢ=0. So the claim is proved and the conclusion follows.

In an embodiment, discrete variables can be separated from the mixed integer decision set of the lower-level problem. A column-and-constraints generation (C&CG) method can be applied to an Extended EI-MDS problem. Theorem 4 can be obtained in a straightforward manner by the strong duality of linear programs (LP).

Theorem 4. The Extended EI-MDS problem is equivalent to the following problem:

$$\begin{matrix}{max}_{y} {min}_{x} ( {\sum }_{{v}_{i} ∈ V} {x}_{i} + {max}_{π} {\sum }_{{v}_{i} ∈ V} {π}_{i} ( 1 - {x}_{i} - {\sum }_{j \text{:} ( {v}_{i} , {v}_{j} ) ∈ E} ( 1 - {y}_{ij} ) {x}_{j} ) ) & ( 11 ) \\ s . t . {π}_{i} \leq 1 , ∀ {v}_{i} ∈ V & ( 12 ) \\ {\sum }_{( {v}_{i} , {v}_{j} ) ∈ E} {c}_{ij} {y}_{ij} \leq B & ( 13 ) \\ {x}_{i} ∈ \{ 0 , 1 \} , {π}_{i} \geq 0 , ∀ {v}_{i} ∈ V & ( 14 ) \\ {y}_{ij} ∈ \{ 0 , 1 \} , ∀ ( {v}_{i} , {v}_{j} ) ∈ E & ( 15 )\end{matrix}$$

The sub-problem can be, for example, an original integer programming (IP) problem or an extended mixed integer programming (MIP) problem. The extended relative completeness holds in the above problem, i.e., for any yεY and for any x⊂B^{|V|}, which may not necessarily be a dominating set, an optimal z or π can be found. Consequently, it can be started, e.g., either from an initial edge interdiction or from any x⊂B^{|V|}. However, the pure integer approach can only start from the former; otherwise, the upper bound in Theorem 1 is not valid. Also, the edge interdiction decision obtained in each iteration of a C&CG algorithm is the best choice with consideration of promising information of its objective value and all the revealed minimum dominating sets. The price of the deep search direction is more computational effort since each iteration a number of 2|E|=2Σ_{vεV}deg(v) binary variables has to be introduced to do linearization in the master problem. The feasible space of the master problem in each iteration is the same with a stochastic programming problem; an algorithm for solving two-stage stochastic programming, e.g., Benders decomposition, can be applied to solve relatively larger-size master and thus the whole problems.

Embodiments of the subject invention can identify a subset of network components, the removal of which lead to diminished performance, down to and including the lowest efficiency performance. In certain embodiments, a subset of network components can be identified, the removal of which lead to improved performance, up to and including the highest efficiency performance. Such components can depend on the system and can include, e.g., flow volume, traveling distance(s), and/or size. Embodiments of the subject invention can help deal with an attack-defend problem.

Embodiments of the subject invention can have many applications, including, but not limited to, critical infrastructure systems (e.g., power grids, military logistics, and sensor networks), cyber security, and bioinformatics.

In an embodiment, a mathematical formulation of a bi-level program can be given by one of the following:

$${max}_{y ∈ Y} {min}_{x ∈ X ( y )} f ( x , y )$$

$$or$$

$${min}_{y ∈ Y} {max}_{x ∈ X ( y )} f ( x , y )$$

Much research assumes the inner/defending problem to be a linear program (LP). Strong duality and Karush-Kuhn-Tucker (KKT) conditions can be adopted in algorithm development, such as the following and a single level (separable) bilinear formulation.

$${min}_{y ∈ Y} {max}_{x ∈ {R}_{+}^{n} \text{:} Ax \leq b - hy} cx \\ ⇒ {min}_{y ∈ Y} {min}_{π ∈ {R}_{+}^{m} \text{:} {A}^{′} π \geq c} {( b - h y )}^{′} π \\ ⇒ {min}_{( y , π ) ∈ {R}_{+}^{( p + m )} \text{:} {A}^{′} π \geq c , y ∈ Y} {( b - h y )}^{′} π$$

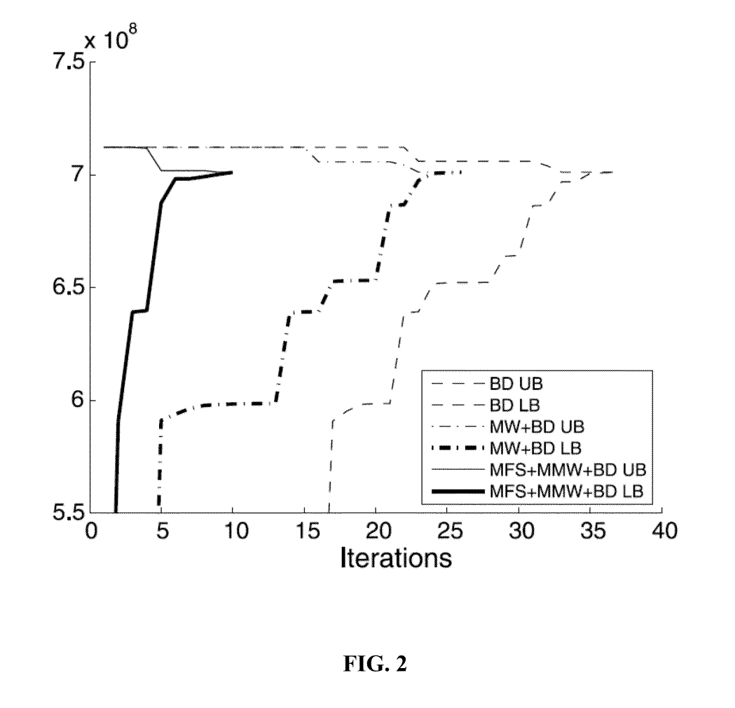

A linearized MIP formulation can be obtainable if Yε{0, 1}^{p}. Strong valid inequalities/cutting planes can strengthen the MIP formulation. However, an LP is often not sufficient to model discrete decisions, such as transmission line switching (e.g., power grid interdiction), clique forming (e.g., social network interdiction), or job scheduling (e.g., nuclear project interdiction problem). The general problem with an MIP inner/defending problem is an important problem with no previous satisfactory solution, which embodiments of the subject invention can solve. Heuristic procedures, such as Benders decomposition methods and meta-heuristics have low quality, while exact algorithms, such as Branch-and-Bound and Branch-and-Cut algorithms, have low efficiency. Enumeration, or evaluating all possible solutions, combinations, and considerations, is not a valid option as it is extremely slow. FIG. 2 shows a graph of performance of different trials of Benders decomposition.

A bi-level formulation is shown below.

$${min}_{y ∈ Y} {max}_{( z , x ) ∈ {Z}_{+}^{{n}_{1}} \times {R}_{+}^{{n}_{2}} \text{:} {A}_{1} z + {A}_{2} z \leq b - hy} {c}_{1} z + {c}_{2 x}$$

A tri-level formulation (I) is shown below.

$${min}_{y ∈ Y} {max}_{( z , x ) ∈ {Z}_{+}^{{n}_{1}}} {c}_{1} z + {max}_{x ∈ {R}_{+}^{{n}_{2}} \text{:} {A}_{2} x \leq b - h y - {A}_{1} z} {c}_{2} x$$

Another tri-level formulation (II), utilizing strong duality of LP, is shown below.

$${min}_{y ∈ Y} {max}_{( z , x ) ∈ {Z}_{+}^{{n}_{1}}} {c}_{1} z + {min}_{π ∈ {R}_{+}^{m} : {A}_{2}^{′} π \geq {c}_{2}} {( b - hy - {A}_{1} z )}^{′} π$$

Since zε{z¹, z², . . . , . . . } is countable, enumeration can begin tri-level formulation (I)

$${min}_{y ∈ Y} {max}_{( z , x ) ∈ {Z}_{+}^{{n}_{1}}} {c}_{1} z + {max}_{x ∈ {R}_{+}^{{n}_{2}} \text{:} {A}_{2} x \leq b - h y - {A}_{1} z} {c}_{2} x ⇒ \\ \begin{matrix}{min}_{y ∈ Y} & η \\ s . t . & η \geq max \{ {c}_{2} {x}^{1} \text{:} {x}^{1} ∈ {R}_{+}^{{n}_{2}} , {A}_{2} {x}^{1} \leq b - hy - {A}_{1} {z}^{1} \} + {c}_{1} {z}^{1} \\ & η \geq max \{ {c}_{2} {x}^{2} \text{:} {x}^{2} ∈ {R}_{+}^{{n}_{2}} , {A}_{2} {x}^{2} \leq b - hy - {A}_{1} {z}^{2} \} + {c}_{1} {z}^{2} \\ & ⋮\end{matrix}$$

Some advantage is gained, but more is needed for complex problems. Due to KKT conditions,

$$\begin{matrix}{min}_{y ∈ Y} & η \\ s . t . & η \geq {c}_{2} {x}^{1} + {c}_{1} {z}^{1} \\ & {x}^{1} ( {A}_{2}^{′} {π}^{1} - {c}_{2} ) = 0 \\ & {π}^{1} ( {A}_{2} {x}^{1} - b + hy + {A}_{1} {z}^{1} ) = 0 \\ & {A}_{2} {x}^{1} \leq b - hy - {A}_{1} {z}^{1} \\ & {A}_{2}^{′} {π}^{1} \geq {c}_{2} \\ & {x}^{1} , {π}^{1} \geq 0 , variables and constraints for {z}^{1} \\ & η \geq {c}_{2} {x}^{2} + {c}_{1} {z}^{2} \\ & {x}^{2} ( {A}_{2}^{′} {π}^{2} - {c}_{2} ) = 0 \\ & {π}^{2} ( {A}_{2} {x}^{2} - b + hy + {A}_{1} {z}^{2} ) = 0 \\ & {A}_{2} {x}^{2} \leq b - hy - {A}_{1} {z}^{2} \\ & {A}_{2}^{′} {π}^{2} \geq {c}_{2} \\ & {x}^{2} , {π}^{2} \geq 0 , variables and constraints for {z}^{2}\end{matrix}$$

Complimentary constraints can be linearized by Big-M methods. A min-max-min formulation is shown below.

$${min}_{y ∈ Y} {max}_{( z , x ) ∈ {Z}_{+}^{{n}_{1}}} {c}_{1} z + {min}_{π ∈ {R}_{+}^{m} : {A}_{2}^{′} π \geq {c}_{2}} {( b - hy - {A}_{1} z )}^{′} π ⇒ \\ \begin{matrix}{min}_{y ∈ Y} & η \\ s . t . & η \geq {( b - hy - {A}_{1} {z}^{1} )}^{′} {π}^{1} + {c}_{1} {z}^{1} \\ & {A}_{2}^{′} {π}^{1} \geq {c}_{2} \\ & {π}^{1} \geq 0 , dual variables and constraints for {z}^{1} \\ & η \geq {( b - hy - {A}_{1} {z}^{2} )}^{′} {π}^{2} + {c}_{1} {z}^{2} \\ & {A}_{2}^{′} {π}^{2} \geq {c}_{2} \\ & {π}^{2} \geq 0 , variables and constraints for {z}^{2}\end{matrix}$$

This provides compact formulation, but it is more appropriate when y and z are binary variables.

In an embodiment, solving a formulation with a partial enumeration can yield a lower bound (LB), and any feasible solution (y*, z(y*), x(y*)) can yield an upper bound (UB). The algorithm can be improved by: augmenting the partial enumeration set to lead to an improved search, the master problem; augmenting the column generation, the sub-problem framework, to identify the next most improving direction (z); and/or establishing a finite number of master/sub-problem communications if z is bounded.

In many embodiments, a column-and-constraint generation (C&CG) algorithm can be used to solve a problem, such as an edge-interdiction problem.

In an embodiment, a C&CG algorithm can include the following steps:
Step 1. Set LB=−∞, UB=+∞, h=0, U=, and an optimality tolerance E.
Step 2. Solve the partial single-level formulation I (or II) (as the master problem). Derive an optimal solution (y*^{h}, η*^{h}) and update LB=η*^{h}.
Step 3. Solve the lower level problem ^{max}(z,x)|y*^{h} (as the sub-problem) and update upper bound=min{UB, opt(y*^{h})}.
Step 4. If UB−LB≦ε, return y*^{h} as an optimal solution and terminate. Otherwise, update U=U∪{h} and h=h+1, create new recourse decision variables (z^{h}, x^{h}) to the partial single-level problem. Go to Step 2.
[An alternative Step 4, which can be used in certain embodiments: If UB−LB≦ε, return y*^{h} as an optimal solution and terminate. Otherwise, update U=U∪{h}, create new continuous recourse decision variables x^{h} corresponding to the obtained z^{h} (parameter obtained in step 3), update h=h+1, and go to step 2.]

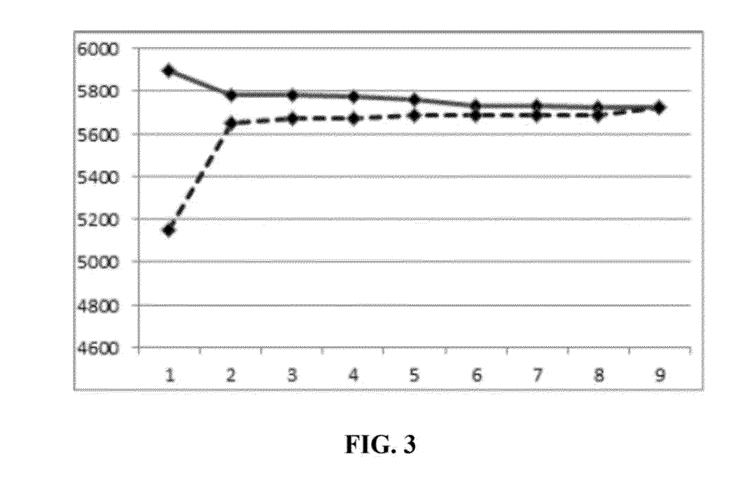

FIG. 3 shows results of implementation of such an algorithm. The number of iterations is shown on the x-axis, and the value of the variables is shown on the y-axis.

Line switching involves disconnecting existing transmission lines, and switching reduces dispatching costs up to 25%. Switching leads to islanding, one of the most effective mitigation approaches to prevent or inhibit cascading.

$${min}_{w ∈ 𝒜} max {\sum }_{j} {d}_{j}^{n}$$

$$s . t . {z}_{l} {w}_{l} ( {θ}_{m} - {θ}_{n} - {x}_{l} {f}_{l}^{mn} ) = 0 , ∀ l \\ - {F}_{l} {z}_{l} {w}_{l} \leq {f}_{l}^{mn} \leq {z}_{l} {w}_{l} {F}_{l} , ∀ l$$

$${p}_{i}^{n} \leq {P}_{i}^{max} , ∀ i$$

$${d}_{j}^{n} \leq {D}_{j}^{n} , ∀ j$$

$${\sum }_{l} {f}_{l}^{. n} + {p}_{i}^{n} = {\sum }_{l} {f}_{l}^{n .} + {d}_{j}^{n} , ∀ n$$

$${p}_{i}^{n} \geq 0 , {d}_{j}^{n} \geq 0 , {f}_{l}^{mn} , {θ}_{n} free , {z}_{l} ∈ \{ 0 , 1 \}$$

$$where 𝒜 = \{ {w}_{l} ∈ \{ 0 , 1 \} , {\sum }_{l} ( 1 - {w}_{l} ) \leq K \} .$$

A tri-level reformulation is shown below.

$${min}_{w ∈ 𝒜} {max}_{z ∈ 𝒞} {min}_{{λ}^{1} , … , {λ}^{7}} {\sum }_{l} {λ}_{l}^{1} ( 1 - {z}_{l} {w}_{l} ) {M}_{l} + {\sum }_{l} {λ}_{l}^{2} ( 1 - {z}_{l} {w}_{l} ) {M}_{l} + {\sum }_{l} {λ}_{l}^{3} {F}_{l} {z}_{l} {w}_{l} + {\sum }_{l} {λ}_{l}^{4} {F}_{l} {z}_{l} {w}_{l} + {\sum }_{i} {λ}_{i}^{5} {P}_{i}^{max} + {\sum }_{j} {λ}_{j}^{6} {D}_{j}^{n}$$

This tri-level formulation is equivalent to the single-level formulation.

$$min η$$

$$s . t . η \geq {\sum }_{l}^{η} {λ}_{l}^{1 ( h )} ( 1 - {\hat{z}}_{l}^{( h )} {w}_{l} ) {M}_{l} + {\sum }_{l} {λ}_{l}^{2 ( h )} ( 1 - {\hat{z}}_{l}^{( h )} {w}_{l} ) {M}_{l} + {\sum }_{l} {λ}_{l}^{3 ( h )} {F}_{l} {\hat{z}}_{l}^{( h )} {w}_{l} + {\sum }_{l} {λ}_{l}^{4 ( h )} {F}_{l} {\hat{z}}_{l}^{( h )} {w}_{l} + {\sum }_{i} {λ}_{i}^{5 ( h )} {P}_{i}^{max} + {\sum }_{j} {λ}_{j}^{6 ( h )} {D}_{j}^{n} , ∀ {\hat{z}}^{( h )} ∈ 𝒞$$

$${λ}_{i}^{5 ( h )} + {λ}_{n \vert i @ n}^{7 ( h )} \geq 0 , ∀ i , h$$

$${λ}_{j}^{6 ( h )} - {λ}_{n \vert j @ n}^{7 ( h )} \geq 1 , ∀ j , h$$

$${x}_{l} {λ}_{l}^{1 ( h )} - {x}_{l} {λ}_{l}^{2 ( h )} - {λ}_{l}^{3 ( h )} + {λ}_{l}^{4 ( h )} - {λ}_{m}^{7 ( h )} + {λ}_{n}^{7 ( h )} = 0 , ∀ l ( m \to n ) , h$$

$${\sum }_{l \vert l = m \to .} ( {λ}_{l}^{2 ( h )} - {λ}_{l}^{1 ( h )} ) + {\sum }_{l \vert l =. \to m} ( {λ}_{l}^{1 ( h )} - {λ}_{l}^{2 ( h )} ) = 0 , ∀ m , h$$

$$w ∈ 𝒜 , η , {λ}^{7 ( h )} free , {λ}^{1 ( h )} , … , {λ}^{6 ( h )} \geq 0$$

$$where {\{ {\hat{z}}^{( h )} \}}_{h = 0}^{H} = 𝒞 .$$

Power grid expansion and nested C&CG strategies can include: network design/capacity expansion to increase generation capacity and add transmission lines; line switching operations after contingencies; and math formulation of defend-attack-defend.

$$min {\sum }_{g ∈ G} {c}_{g} {z}_{g} + {\sum }_{e ∈ E} {c}_{e} {z}_{e} + {max}_{v ∈ V} {min}_{( w )} {\sum }_{n ∈ 𝒩} {d}_{n}$$

$$s . t . {p}_{l} {x}_{l} = {w}_{l} {v}_{l} [ {δ}_{O ( l )} - {δ}_{D ( l )} ] , ∀ l$$

$${p}_{e} {x}_{e} = {w}_{e} {v}_{e} {z}_{e} [ {δ}_{O ( l )} - {δ}_{D ( l )} ] , ∀ e$$

$${\sum }_{j ∈ Jn} {p}_{j} + {\sum }_{g ∈ Gn} {p}_{g} - {\sum }_{l \vert O ( l ) = n} {p}_{l} + {\sum }_{l \vert D ( l ) = n} {p}_{l} - {\sum }_{l \vert O ( l ) = n} {p}_{l} + {\sum }_{l \vert D ( l ) = n} {p}_{l} + {d}_{n} = {D}_{n} , ∀ n \\ - {p}_{l}^{max} \leq {p}_{l} \leq {p}_{l}^{max} , ∀ l \\ - {p}_{e}^{max} \leq {p}_{e} \leq {p}_{e}^{max} , ∀ e$$

$$0 \leq {p}_{j} \leq {p}_{j}^{max} , ∀ j$$

$$0 \leq {p}_{g} \leq {z}_{g} {p}_{g}^{max} , ∀ g$$

$$0 \leq {d}_{n} \leq {D}_{n} , ∀ n$$

$${z}_{e} , {z}_{g} , {v}_{l} , {v}_{e} , {w}_{l} , {w}_{e} ∈ \{ 0 , 1 \}$$

If there is no continuous variable in the defender's decision model, then in application, the network can be disrupted to minimize the largest clique (min-max) or to maximize the minimum dominating set (max-min). If all cliques of size k+1 will be infeasible after an attack, then the upper bound will be k. If no attack can make the clique infeasible, the lower bound will be k. A C&CG variant can be developed based on these observations.

In an embodiment, an algorithm can be used to solve an edge-interdiction minimum dominating set problem and reliable feature selection problem (a min-max weighted clique problem).

In an embodiment, a finitely-convergent algorithm can be used to solve a zero-sum attack-defend problem.

In an embodiment, a nested algorithm implementation can be used to solve a tri-level mixed-integer defend-attack-defend problem.

In an embodiment, an extension to an algorithm as disclosed herein can be used to solve a pure discrete defend problem.

In certain embodiments, graph-theory-based algorithms and approximation algorithms can be used for better convergence.

In an embodiment, an interdiction problem can be formulated as a tri-level optimization problem with a mixed-integer recourse problem. The overall load shedding in contingencies can be minimized.

$$s . t . {p}_{l} {x}_{l} = {w}_{l} ( {z}_{l} + {v}_{l} - {z}_{l} {v}_{l} ) [ {δ}_{o ( l )} - {δ}_{d ( l )} ] , ∀ l$$

$${\sum }_{j ∈ Jn} {g}_{j} - {\sum }_{l \vert o ( l ) = n} {p}_{l} + {\sum }_{l \vert d ( l ) = n} {p}_{l} + {d}_{n} = {D}_{n} , ∀ n \\ - {p}_{l}^{max} \leq {p}_{l} \leq {p}_{l}^{max} , ∀ l$$

$${δ}^{max} \leq {δ}_{n} \leq {δ}^{max} , ∀ n$$

$$0 \leq {g}_{j} \leq {g}_{j}^{max} , ∀ j$$

$$0 \leq {d}_{n} \leq {D}_{n} , ∀ n$$

$${z}_{l} , {w}_{l} , {v}_{l} ∈ \{ 0 , 1 \} , ∀ l$$

$$• = \{ {z}_{l} ∈ \{ 0 , 1 \} , {\sum }_{l} {z}_{l} \leq Z \}$$

defender's hardening decision set.

$$V = \{ {v}_{l} ∈ \{ 0 , 1 \} , {\sum }_{l} ( 1 - {v}_{l} ) \leq M \}$$

attacker's attack decision set

wₗ is the binary line switching decision variable for line l.

pₗ, gⱼ, dₙ, δₙ are decision variables for line power flow,

generating level of generators, load shed, and phase angles

Column-and-constraints generation (C&CG) is an efficient algorithm of the subject invention to solve tri-level optimization problems. A C&CG algorithm can be implemented in a two-level master-sub problem framework. In an embodiment, a nested C&CG (NCCG) algorithm can be used. KKT conditions and strong duality can be applied to convert a bi-level (max-min) sub-problem to its tri-level reformulation (max-min-max).

NCCG Master Problem:

$$min α$$

$$s . t . α \geq {\sum }_{n} {d}_{n}^{i} , ∀ i = 1 , … , k$$

$${p}_{l}^{i} {x}_{l} = {w}_{l}^{i} ( {z}_{l} + {\hat{v}}_{l}^{i} - {z}_{l} {\hat{v}}_{l}^{i} ) [ {δ}_{o ( l )}^{i} - {δ}_{d ( l )}^{i} ] , ∀ l , i = 1 , … , k$$

$${\sum }_{j ∈ Jn} {g}_{j}^{i} - {\sum }_{l \vert o ( l ) = n} {p}_{l}^{i} + {\sum }_{l \vert d ( l ) = n} {p}_{l}^{i} + {d}_{n}^{i} = {D}_{n} , ∀ n , ∀ i = 1 , … , k \\ - {p}_{l}^{max} \leq {p}_{l}^{i} \leq {p}_{l}^{max} , ∀ l , ∀ i = 1 , … , k$$

$$0 \leq {g}_{j}^{i} \leq {p}_{j}^{max} , ∀ j , ∀ i = 1 , … , k \\ - {δ}^{max} \leq {δ}_{n}^{i} \leq {δ}^{max} , ∀ n , ∀ i = 1 , … , k$$

$$0 \leq {d}_{n}^{i} \leq {D}_{n} , ∀ n , ∀ i = 1 , … , k$$

$${w}_{l}^{i} , {z}_{l} ∈ \{ 0 , 1 \}$$

NCCG Sub-Problem:

$${max}_{v ∈ V} {min}_{w ∈ W} {\sum }_{n ∈ N} {d}_{n}$$

$$s . t . {p}_{l} {x}_{l} = {w}_{l} ( {\hat{z}}_{l} + {v}_{l} - {\hat{z}}_{l} {v}_{l} ) [ {δ}_{o ( l )} - {δ}_{d ( l )} ] = 0 , ∀ l$$

$${\sum }_{j ∈ Jn} {g}_{j} - {\sum }_{l \vert o ( l ) = n} {p}_{l} + {\sum }_{l \vert d ( l ) = n} {p}_{l} + {d}_{n} = {D}_{n} , ∀ n \\ - {p}_{l}^{max} \leq {p}_{l} \leq {p}_{l}^{max} , ∀ l$$

$$0 \leq {g}_{j} \leq {g}_{j}^{max} , ∀ j \\ - {δ}^{max} \leq {δ}_{n} \leq {δ}^{max} , ∀ n$$

$$0 \leq {d}_{n} \leq {D}_{n} , ∀ n$$

$${v}_{l} , {w}_{l} ∈ \{ 0 , 1 \}$$

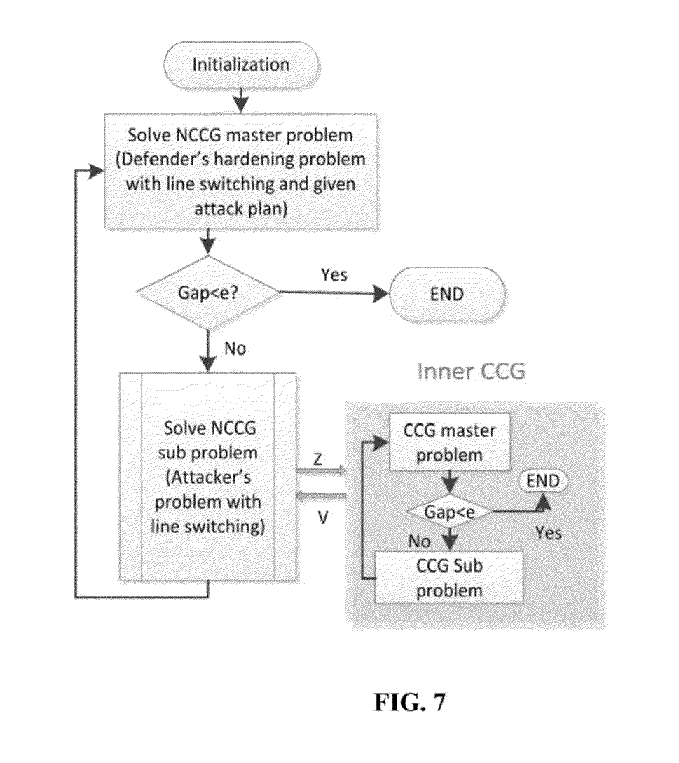

The key of NCCG is to solve the tri-level reformulation of the sub-problem by a (nesting) C&CG procedure. The NCCG algorithm can be implemented in a nested manner. An inner C&CG procedure can be applied to solve the NCCG sub-problem using its tri-level reformulation. FIG. 7 shows a flow chart of an algorithm according to an embodiment of the subject invention.

In the following discussion, the use of a “̂” over a variable (or with “hat” written out after the variable in text−e.g., “w-hat”) can denote a decision variable with a fixed value. That is, it can become a parameter when its value is given.

The objective function in the a min-max formulation in can be equivalently expressed as

$${min}_{w ∈ 𝒜} {max}_{z , p , f , θ , d} {\sum }_{j} {d}_{j}^{n} = {min}_{w ∈ 𝒜} {max}_{z ∈ 𝒞} {max}_{p , f , θ , d} {\sum }_{j} {d}_{j}^{n}$$

where C is the binary set including all possible line switching decisions. Although such an extension from a bi-level model into tri-level is counterintuitive as it seems, at least temporarily, to increase the complexity of the problem, it provides a mechanism to isolate the line switching set from other dispatching decisions. In particular, it can be further converted into a single-level problem.

To see this, for any given attack w-hatεA and switching decision z-hat, the remaining problem, which is actually the classical dispatching problem, is a pure LP problem. Furthermore, this LP problem is always feasible in that the solution with {p, f, θ, d}=0 is feasible in all cases. Therefore, the strong duality holds, and the maximization dispatching problem can be equivalently replaced by its minimization dual problem. The corresponding dual problem, where λ¹−λ⁷ are dual variables for constraints, can be presented. Note that n|i@n and n|j@n denote the bus n with generator i or demand j, respectively. Also, l|l=m→ and l/l=→m denote the transmission line with bus m as the start and end bus, respectively.

$$min {\sum }_{l}^{η} {λ}_{l}^{1} ( 1 - {\hat{z}}_{l} {\hat{w}}_{l} ) {M}_{l} + {\sum }_{l} {λ}_{l}^{2} ( 1 - {\hat{z}}_{l} {\hat{w}}_{l} ) {M}_{l} + {\sum }_{l} {λ}_{l}^{3} {F}_{l} {\hat{z}}_{l} {\hat{w}}_{l} + {\sum }_{l} {λ}_{l}^{4} {F}_{l} {\hat{z}}_{l} {\hat{w}}_{l} + {\sum }_{i} {λ}_{i}^{5} {P}_{i}^{max} + {\sum }_{j} {λ}_{j}^{6} {D}_{j}^{n}$$

$$s . t . {λ}_{i}^{5} + {λ}_{n \vert i @ n}^{7} \geq 0 , ∀ i$$

$${λ}_{j}^{6} - {λ}_{n \vert j @ n}^{7} \geq 1 , ∀ j$$

$${x}_{l} {λ}_{l}^{1} - {x}_{l} {λ}_{l}^{2} - {λ}_{l}^{3} + {λ}_{l}^{4} - {λ}_{m}^{7} + {λ}_{n}^{7} = 0 , ∀ l ( m \to n )$$

$${\sum }_{l \vert l = m \to .} ( {λ}_{l}^{2} - {λ}_{l}^{1} ) + {\sum }_{l \vert l =. \to m} ( {λ}_{l}^{1} - {λ}_{l}^{2} ) = 0 , ∀ m$$

$${λ}^{7} free , {λ}^{1} , … , {λ}^{6} \geq 0$$

Then, the min-max power network interdiction model can be reformulated into an equivalent single-level model through Propositions 4-6 in the following.

Proposition 4. The following min-max problem:

$${min}_{w ∈ 𝒜} {max}_{\{ p , d , f , θ , z \}} {\sum }_{j} {d}_{j}^{n}$$

$$s . t . {z}_{l} {w}_{l} ( {θ}_{m} - {θ}_{n} - {x}_{l} {f}_{l}^{mn} ) = 0 , ∀ l \\ - {F}_{l} {z}_{l} {w}_{l} \leq {f}_{l}^{mn} \leq {z}_{l} {w}_{l} {F}_{l} , ∀ l$$

$${p}_{i}^{n} \leq {P}_{i}^{max} , ∀ i$$

$${d}_{j}^{n} \leq {D}_{j}^{n} , ∀ j$$

$${\sum }_{l} {f}_{l}^{. n} + {p}_{i}^{n} = {\sum }_{l} {f}_{l}^{n .} + {d}_{j}^{n} , ∀ n$$

$${p}_{i}^{n} \geq 0 , {d}_{j}^{n} \geq 0 , {f}_{l}^{mn} , {θ}_{n} free , {z}_{l} ∈ \{ 0 , 1 \}$$

$$where 𝒜 = \{ w ∈ {𝔹}^{L} \text{:} {w}_{l} ∈ \{ 0 , 1 \} , {\sum }_{l} ( 1 - {w}_{l} ) \leq K \} .$$

is equivalent to the following tri-level programming problem:

$${min}_{w ∈ 𝒜} {max}_{z ∈ 𝒞} {min}_{{λ}^{1} , … , {λ}^{7}} {\sum }_{l} {λ}_{l}^{1} ( 1 - {z}_{l} {w}_{l} ) {M}_{l} + {\sum }_{l} {λ}_{l}^{2} ( 1 - {z}_{l} {w}_{l} ) {M}_{l} + {\sum }_{l} {λ}_{l}^{3} {F}_{l} {z}_{l} {w}_{l} + {\sum }_{l} {λ}_{l}^{4} {F}_{l} {z}_{l} {w}_{l} + {\sum }_{i} {λ}_{i}^{5} {P}_{i}^{max} + {\sum }_{j} {λ}_{j}^{6} {D}_{j}^{n}$$

Note that it can easily be proven by strong duality of the linear program of the innermost maximization problem in the following equation, which was presented above:

$${min}_{w ∈ 𝒜} {max}_{z , p , f , θ , d} {\sum }_{j} {d}_{j}^{n} = {min}_{w ∈ 𝒜} {max}_{z ∈ 𝒞} {max}_{p , f , θ , d} {\sum }_{j} {d}_{j}^{n}$$

Proposition 5. The tri-level model defined above is equivalent to the single-level form defined here:

$$min η$$

$$s . t . η \geq {\sum }_{l}^{η} {λ}_{l}^{1 ( h )} ( 1 - {\hat{z}}_{l}^{( h )} {w}_{l} ) {M}_{l} + {\sum }_{l} {λ}_{l}^{2 ( h )} ( 1 - {\hat{z}}_{l}^{( h )} {w}_{l} ) {M}_{l} + {\sum }_{l} {λ}_{l}^{3 ( h )} {F}_{l} {\hat{z}}_{l}^{( h )} {w}_{l} + {\sum }_{l} {λ}_{l}^{4 ( h )} {F}_{l} {\hat{z}}_{l}^{( h )} {w}_{l} + {\sum }_{i} {λ}_{i}^{5 ( h )} {P}_{i}^{max} + {\sum }_{j} {λ}_{j}^{6 ( h )} {D}_{j}^{n} , ∀ {\hat{z}}^{( h )} ∈ 𝒞$$

$${λ}_{i}^{5 ( h )} + {λ}_{n \vert i @ n}^{7 ( h )} \geq 0 , ∀ i , h$$

$${λ}_{j}^{6 ( h )} - {λ}_{n \vert j @ n}^{7 ( h )} \geq 1 , ∀ j , h$$

$${x}_{l} {λ}_{l}^{1 ( h )} - {x}_{l} {λ}_{l}^{2 ( h )} - {λ}_{l}^{3 ( h )} + {λ}_{l}^{4 ( h )} - {λ}_{m}^{7 ( h )} + {λ}_{n}^{7 ( h )} = 0 , ∀ l ( m \to n ) , h$$

$${\sum }_{l \vert l = m \to .} ( {λ}_{l}^{2 ( h )} - {λ}_{l}^{1 ( h )} ) + {\sum }_{l \vert l =. \to m} ( {λ}_{l}^{1 ( h )} - {λ}_{l}^{2 ( h )} ) = 0 , ∀ m , h$$

$$w ∈ 𝒜 , η , {λ}^{7 ( h )} free , {λ}^{1 ( h )} , … , {λ}^{6 ( h )} \geq 0$$

$$where {\{ {\hat{z}}^{( h )} \}}_{h = 0}^{H} = 𝒞 .$$

Proof. The tri-level programming problem in Proposition 1 is equivalent to the following program:

$${min}_{w ∈ 𝒜} η$$

$$s . t . η \geq {max}_{z ∈ 𝒞} {min}_{{λ}^{1} , … , {λ}^{7}} {\sum }_{l} {λ}_{l}^{1} ( 1 - {z}_{l} {w}_{l} ) {M}_{l} + {\sum }_{l} {λ}_{l}^{2} ( 1 - {z}_{l} {w}_{l} ) {M}_{l} + {\sum }_{l} {λ}_{l}^{3} {F}_{l} {z}_{l} {w}_{l} + {\sum }_{l} {λ}_{l}^{4} {F}_{l} {z}_{l} {w}_{l} + {\sum }_{i} {λ}_{i}^{5} {P}_{i}^{max} + {\sum }_{j} {λ}_{j}^{6} {D}_{j}^{n} .$$

Note that C is a finite discrete set that contains all the line switching decisions, i.e., c={\hat{z}^{(h)}}ₕ₌₀^{H} By enumeration, it follows that the above program is equivalent to the following formulation:

$${min}_{w ∈ 𝒜} η$$

$$s . t . η \geq {min}_{{λ}^{( h )}} {\sum }_{l} {λ}_{l}^{1 ( h )} ( 1 - {\hat{z}}_{l}^{( h )} {w}_{l} ) {M}_{l} + {\sum }_{l} {λ}_{l}^{2 ( h )} ( 1 - {\hat{z}}_{l}^{( h )} {w}_{l} ) {M}_{l} + {\sum }_{l} {λ}_{l}^{3} {F}_{l} {z}_{l} {w}_{l} + {\sum }_{l} {λ}_{l}^{4} {F}_{l} {z}_{l} {w}_{l} + {\sum }_{i} {λ}_{i}^{5} {P}_{i}^{max} + {\sum }_{j} {λ}_{j}^{6} {D}_{j}^{n} .$$

Note that λ(h) are independent for different h in the sense that each set of λ^{(h)} is generated for a feasible line switching decision. Then, by removing the “min” in the first set of constraints, which does not change the optimal value, we obtain the equivalent program in Proposition 2.

In the above single-level equivalent form, decision variables are w and (λ^{1(h)}, . . . , λ^{7(h)}) for all h. The proposition involves terms that are products of one binary variable, wₗ, and one continuous variable λ^{k(h)} with k=1, . . . , 4. The mathematical programming problems with mixed-integer nonlinear constraints are in general very difficult. So, it would be natural to linearize those terms using standard linearization techniques so that professional MIP solvers can be called to solve this problem. Assume that M′ₖₗ is a sufficiently large number that provides an upper bound to optimal values of λₗ^{k(h)} in the equations provided just above Proposition 4, we can have the following equivalent linear constraints.

Proposition 6. Constraints defined in the third line of Proposition 5 can be linearized as follows:

$$η \geq {\sum }_{l} ( {λ}_{l}^{1 ( h )} - {\hat{z}}_{l}^{( h )} {α}_{l}^{( h )} ) {M}_{l} + {\sum }_{l} ( {λ}_{l}^{2 ( h )} - {\hat{z}}_{l}^{( h )} {β}_{l}^{( h )} ) {M}_{l} + {\sum }_{l} {π}_{l}^{( h )} {F}_{l} {\hat{z}}_{l}^{( h )} + {\sum }_{l} {μ}_{l}^{( h )} {F}_{l} {\hat{z}}_{l}^{( h )} + {\sum }_{i} {λ}_{i}^{5 ( h )} {P}_{i}^{max} + {\sum }_{j} {λ}_{j}^{6 ( h )} {D}_{j}^{n} , ∀ {\hat{z}}^{( h )} ∈ C$$

$${α}_{l}^{( h )} \leq {λ}_{l}^{1 ( h )} , ∀ h , l$$

$${α}_{l}^{( h )} \geq {λ}_{l}^{1 ( h )} - ( 1 - {w}_{l} ) {M}_{1 l}^{′} , ∀ h , l$$

$${α}_{l}^{( h )} \leq {w}_{l} {M}_{1 l}^{′} , ∀ h , l$$

$${β}_{l}^{( h )} \leq {λ}_{l}^{2 ( h )} , ∀ h , l$$

$${β}_{l}^{( h )} \geq {λ}_{l}^{2 ( h )} - ( 1 - {w}_{l} ) {M}_{2 l}^{′} , ∀ h , l$$

$${β}_{l}^{( h )} \leq {w}_{l} {M}_{2 l}^{′} , ∀ h , l$$

$${π}_{l}^{( h )} \leq {λ}_{l}^{3 ( h )} , ∀ h , l$$

$${π}_{l}^{( h )} \geq {λ}_{l}^{3 ( h )} - ( 1 - {w}_{l} ) {M}_{3 l}^{′} , ∀ h , l$$

$${π}_{l}^{( h )} \leq {w}_{l} {M}_{3 l}^{′} , ∀ h , l$$

$${μ}_{l}^{( h )} \leq {λ}_{l}^{4 ( h )} , ∀ h , l$$

$${μ}_{l}^{( h )} \geq {λ}_{l}^{4 ( h )} - ( 1 - {w}_{l} ) {M}_{4 l}^{′} , ∀ h , l$$

$${μ}_{l}^{( h )} \leq {w}_{l} {M}_{4 l}^{′} , ∀ h , l$$

$${π}_{l}^{( h )} , {μ}_{l}^{( h )} , {α}_{l}^{( h )} , {β}_{l}^{( h )} \geq 0$$

As a result, the bi-level power interdiction problem defined below can be reformulated as a mixed-integer programming problem:

$${min}_{w ∈ 𝒜} {max}_{\{ p , d , f , θ , z \}} {\sum }_{j} {d}_{j}^{n}$$

$$s . t . {z}_{l} {w}_{l} ( {θ}_{m} - {θ}_{n} - {x}_{l} {f}_{l}^{mn} ) = 0 , ∀ l \\ - {F}_{l} {z}_{l} {w}_{l} \leq {f}_{l}^{mn} \leq {z}_{l} {w}_{l} {F}_{l} , ∀ l$$

$${p}_{i}^{n} \leq {P}_{i}^{max} , ∀ i$$

$${d}_{j}^{n} \leq {D}_{j}^{n} , ∀ j$$

$${\sum }_{l} {f}_{l}^{. n} + {p}_{i}^{n} = {\sum }_{l} {f}_{l}^{n .} + {d}_{j}^{n} , ∀ n$$

$${p}_{i}^{n} \geq 0 , {d}_{j}^{n} \geq 0 , {f}_{l}^{mn} , {θ}_{n} free , {z}_{l} ∈ \{ 0 , 1 \}$$

$$where 𝒜 = \{ w ∈ {𝔹}^{L} ; {w}_{l} ∈ \{ 0 , 1 \} , {\sum }_{l} ( 1 - {w}_{l} ) \leq K \} .$$

Corollary 3. The equivalent single-level linear MIP formulation of the bi-level power grid interdiction problem is the one obtained by replacing the third line of Proposition 5 with the equations in Proposition 6 in the formulation of Proposition 5.

The min-max power interdiction problem can be converted into a single-level MIP problem, as discussed above. However, this single-level equivalent form is of theoretical interest only. As a set of λ^{1(h)}, . . . , λ^{7(h)}) and their corresponding constraints must be introduced for any possible z-hat in set C, which is actually exponential with respect to the number of lines in the grid, therefore it is not feasible to enumerate all possible line switching decisions for any real instances. Instead of using the complete enumeration to obtain the equivalent form, an algorithm as described herein can dynamically identify and include significant line switching decisions and dual decisions of their corresponding dispatching decisions, i.e., the barrier of complete enumeration can be removed.

In an embodiment, an algorithm can start with a single-level formulation with a small subset of C (i.e., their variables and constraints) and then gradually expand the formulation by including more significant components (i.e., their variables and constraints) of C. Note from Proposition 5 that a single-level formulation with a subset of C, which is named the partial single-level formulation, yields a lower bound to the actual optimal value. Also, any feasible solution to the min-max formulation, which can be obtained for any attack plan, yields an upper bound, given that the ultimate objective function is minimization. Therefore, the expansion process can be terminated with an optimal solution whenever upper and lower bounds match. This idea can be implemented within a master-subproblem framework using a C&CG approach as follows. To simplify, let y={p, d, f, θ, z} denote the set of decision variables, including line switching and other dispatching variables, made by system operator, then the lower level decision model given any attack w-hatεA will be (call this the subproblem formulation):

max cy

st. By≦g−Aŵ
variable restrictions on y,
   where c, g, B, A are appropriate vectors or matrices defined in:

$${min}_{w ∈ 𝒜} {max}_{\{ p , d , f , θ , z \}} {\sum }_{j} {d}_{j}^{n}$$

$$s . t . {z}_{l} {w}_{l} ( {θ}_{m} - {θ}_{n} - {x}_{l} {f}_{l}^{mn} ) = 0 , ∀ l \\ - {F}_{l} {z}_{l} {w}_{l} \leq {f}_{l}^{mn} \leq {z}_{l} {w}_{l} {F}_{l} , ∀ l$$

$${p}_{i}^{n} \leq {P}_{i}^{max} , ∀ i$$

$${d}_{j}^{n} \leq {D}_{j}^{n} , ∀ j$$

$${\sum }_{l} {f}_{l}^{. n} + {p}_{i}^{n} = {\sum }_{l} {f}_{l}^{n .} + {d}_{j}^{n} , ∀ n$$

$${p}_{i}^{n} \geq 0 , {d}_{j}^{n} \geq 0 , {f}_{l}^{mn} , {θ}_{n} free , {z}_{l} ∈ \{ 0 , 1 \}$$

$$where 𝒜 = \{ w ∈ {𝔹}^{L} ; {w}_{l} ∈ \{ 0 , 1 \} , {\sum }_{l} ( 1 - {w}_{l} ) \leq K \} .$$

Similarly, for some known {z^{(h)}}_{hεU}⊂C, the partial single-level formulation is (call this the mast problem formulation):

min η

st. Qη+Eλ^{(h)}+Gw≦h\hat{z}^{(h)}+a, ∀hεu
wεA
variable restriction on w, η, λ^{(h)},
   where h, a, Q, E, G are appropriate vectors or matrices defined in the equations in Propositions 5 and 6.

Thus, in an embodiment, an algorithm can have the following steps:
Step 1. Set LB=−∞, UB=+∞, h=0, U=, and an optimality tolerance ε.
Step 2. Solve the partial single-level defined above as the master problem formulation (as the master problem). Derive an optimal solution (w*^{h}, η*^{h}, λ*^{h}) and update LB=η*^{h}.
Step 3. Solve the lower level problem defined above as the subproblem formulation (as the sub-problem) with w-hat=w*^{h} and update upper bound=min{UB, cy*}, where y*, including the optimal line switching z*, is the optimal solution of the lower level problem.
Step 4. If UB−LB≧ε, return w*^{h} as an optimal attack plan and terminate. Otherwise, update U=U∪{h} with z-hat^{(h)}−z*, create new recourse decision variables λ^{(h)}, and add the corresponding constraints defined in the second line of the master problem formulation defined above to go to the partial single level problem. Let h=h+1, and go to Step 2.

Given the fact that C is a finite binary set, it follows directly that the number of iterations of C&CG algorithm is finite and it converges to an optimal solution. The proof is provided here.
Proof. We claim that any repeated z* in above procedure implies global optimality, i.e., LB=UB. Then the conclusion follows immediately due to the finite number of points in C.
Suppose at iteration q an optimal attack w* is obtained by solving the (master) problem in Step 2) of the algorithm in Section III. And for this given w*, let y* which includes z* and d* be the optimal solution to the subproblem in Step 3). It follows that UB≦cy*=Σⱼdⱼⁿ*. Assume z* has been identified at or before iteration q−1, it will have two consequences. First, w* will be the optimal solution to the (master) problem in Step 2) at iteration q+1 because the problems at these two iterations are identical. Second, since the constraints and variables (19-38) related to z* are already added to the master problem, we will have for iteration q+1 that LB=η*≧min{Σₗλₗ¹(1−xₗ*wₗ*)Mₗ+Σₗλₗ²(1−zₗ*wₗ*)Mₗ+Σₗλₗ³Fₗzₗ*wₗ*+Σₗλₗ⁴Fₗzₗ*wₗ*+Σᵢλᵢ⁵ ᵢ^{pmar}+Σⱼλⱼ⁶Dⱼⁿ: (12-16)}=Σⱼdⱼⁿ*, where the inequality comes from constraint (19) and the last equality results from the strong duality of a linear programming problem. Now we have Σⱼdⱼⁿ*≦LB≦UB≦Σⱼdⱼⁿ*, so the equality will go through, i.e., LB=UB.

Note from the algorithm description that many variables and constraints may be introduced in each iteration, which increases the complexity of the master problem. However, the strength of the newly-added constraints is strong, and the algorithm usually derives an optimal solution after a small number of iterations. The studies in the examples confirm this where a global optimal solution can be obtained after a few iterations for all instances.

In certain embodiments, an algorithm as described herein can be included on or in a computer system. The computer system can have hardware including, e.g., one or more central processing units (CPUs), memory, mass storage (e.g., hard drive), and I/O devices (e.g., network interface, user input devices). Elements of the computer system hardware can communicate with each other via a bus. The computer system hardware can be configured according to any suitable computer architectures including, but not limited to, a Symmetric Multi-Processing (SMP) architecture or a Non-Uniform Memory Access (NUMA) architecture. The one or more CPUs can include multiprocessors or multi-core processors and can operate according to one or more suitable instruction sets including, but not limited to, a Reduced Instruction Set Computing (RISC) instruction set, a Complex Instruction Set Computing (CISC) instruction set, or any combination thereof, though embodiments are not limited thereto. In certain embodiments, one or more digital signal processors (DSPs) can be included as part of the computer hardware of the system in place of or in addition to a general purpose CPU.

In certain embodiments of the invention, an algorithm as described herein can be included on a network. The network can be any suitable communications network including, but not limited to, a cellular (e.g., wireless phone) network, the Internet, a local area network (LAN), a wide area network (WAN), a WiFi network, or any combination thereof. Such networks are widely used to connect various types of network elements, such as routers, servers, and gateways. It should also be understood that the invention can be practiced in a multi-network environment having various connected public and/or private networks.

Certain embodiments of the invention can be practiced in distributed-computing environments where tasks are performed by remote-processing devices that are linked through a communications network. In a distributed-computing environment, program modules can be located in both local and remote computer storage media. Computer storage media include computer-readable media that may contain instructions that implement the various applications and systems described herein.

In certain embodiments, the methods and algorithms described herein can be embodied as code and/or data. The software code and data described herein can be stored on one or more computer readable media (e.g., non-transitory media), which can include any device or medium that can store code and/or data for use by a computer system. When a computer system reads and executes the code and/or data stored on a computer-readable medium, the computer system performs the method(s) and/or algorithm(s) embodied as data structures and code stored within the computer-readable storage medium. Computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM), non-volatile memory such as flash memory, various read-only-memories (ROM, PROM, EPROM, EEPROM), magnetic and ferromagnetic/ferroelectric memories (MRAM, FeRAM), magnetic and optical storage devices (hard drives, magnetic tape, CDs, DVDs), and other media now known or later developed that is capable of storing computer-readable information/data for use by a computer system. Computer-readable media should not be construed or interpreted to include any propagating signals.

In certain embodiments, the methods and algorithms described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware module(s) perform(s) the method(s) and/or algorithm(s) included within the hardware module(s).

In certain embodiments, the methods and algorithms described herein can be implemented in the general context of computer-executable instructions, such as program modules, executed by one or more computers or other devices. Certain embodiments of the invention contemplate the use of a computer system or virtual machine within which a set of instructions, when executed, can cause the system to perform any one or more of the methodologies discussed above. Generally, program modules include routines, programs, objects, components, and data structures that perform particular tasks or implement particular abstract data types.

The methods and algorithms described herein are not only efficient but unique to solve several types of problems, including a bi-level min-max problem with mixed-integer lower level, and tri-level min-max-min problems with a MIP recourse problem (i.e., the inner most one is MIP).

All patents, patent applications, provisional applications, and publications referred to or cited herein are incorporated by reference in their entirety, including all figures and tables, to the extent they are not inconsistent with the explicit teachings of this specification.

Following are examples that illustrate procedures for practicing the invention. These examples should not be construed as limiting. All percentages are by weight and all solvent mixture proportions are by volume unless otherwise noted.

### Example 1

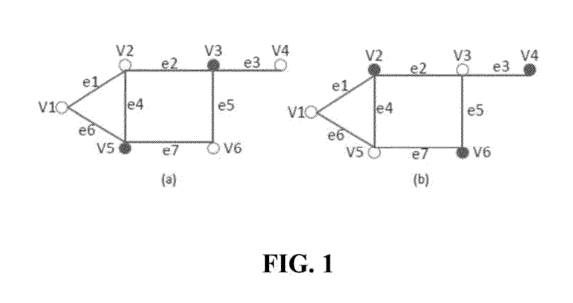

Referring to FIG. 1A, an example of a graph G with γ(G)=2 is shown. If the budget constraint is Σ_{eεE}yₑ<1, the upper bound of EI-MDS is 3. If e₃ is interdicted (by, e.g, guessing or a heuristic algorithm), γ(G {e₃})=3=γ(G)+L, therefore yₑ₃=1 can be claimed to be the global optimal. If the budget is Σ_{eεE}yₑ<2, however, it is difficult for heuristic algorithms to confirm global optimality.

Iteration 1. Take E(y¹)={e₁, e₂}, then D₁=V(x¹)={v₁, v₂} shown in red in subgraph (a). Update y^{x}=y¹ and η=2. And we have {Fₙ(D₁):∀uε D̅₁̅}={Fₙ(D₁): uε{v₁, v₂, v₄, v₆}}={{e₆}, {e₂, e₄}, {e₃}, {e₅, e₇}}. Since the following system

$$P = \{ \begin{matrix}{\sum }_{e ∈ E} {y}_{e} \leq 2 , \\ \text{?} \\ {y}_{e} ∈ \{ 0 , 1 \} , ∀ e ∈ E .\end{matrix} \}$$

$$\text{?} \text{indicates text missing or illegible when filed}$$

is feasible, i.e., y₃=y₆=1 and yₑ=0 for other edges eεE, a desired w is obtained. In fact, the constraint (6) can be linearized as follows.

y₆+y₈+y₃+yₑ≧1, y₈≦y₂, y₈≦y₄

y₉≦y₅, y₉≦y⁷, y₈, y₉ε{0,1}

In the following iterations, linearization is omitted for simplicity. Also, for any nonlinear constraint (one such constraint per iteration), the number of the newly-introduced binary variables is no more than |V|−r(G).

Iteration 2. E(y²)={e₃, e₈}, D₂=V(x²)={v₃, v₂, v₆} shown in (b). Since ∥x²∥₁=3>2, update y*=y² and η=3. And we have {Fₙ(D₂):∀uε D̅₂̅}={{e₁}, {e₄, e₇}, {e₂, e₃, e₅}}. The following constraint is added to system P:

y₁+y₄y₇+y₂y₃y₅≧1

One of the feasible solutions is yₗ=y₃=1 and yₑ=0 for other edges eεE.

Iteration 3. E(y³)={e₁, e₃}, D₂=V(x³)={v₃, v₂, v₆}. Since ∥x³∥₁=3, we do not update y* and η. In addition, we have {Fₙ(D₃):∀uε D̅₃̅}={{e₆}, {e₂, e₄}, {e₅, e₇}}. The following constraint is added to system P:

y₆+y₂y₄+y₅y₇≧1

One of the feasible solutions is y₁=y₆=1 and yₑ=0 for other edges eεE.

Iteration 4. E(y⁴)={e₁, e₆}, D₄=V(x⁴)={v₁, v₃, v₇}. Since ∥x⁴∥₁=3, we do not update y* and η. In addition, we have {Fₙ(D₄):∀uε D̅₄̅}={{e₃}, {e₂, e₄}, {e₅, e₇}}. The following constraint

y₃+y₂y₄+y₅y₇≧1

is added to system P.

Now, system P is infeasible, so the algorithm stops, and it can be claimed that y is a global optimal solution with objective value η=3.

### Example 2

A computational study was conducted to show/compare the effectiveness of methods of the subject invention, particularly the pure integer approach (e.g., Theorems 1 and 2) and the mixed-integer approach (e.g. Theorems 3 and 4). All instances were complex graphs with multiple edges and loops. Table 1 shows the performance of the pure integer approach for a graph with 30 vertices and 50 edges with and without the improved upper bound. The effectiveness of the algorithm for two medium-sized graphs with 300 vertices and 500 edges is shown in Table 2. The results for the two medium sizes may be slightly biased since the upper bound provided in Lemma 1 is optimal for the two instances.

TABLE 1
Results for Pure Integer Approach

| | Time(s) | Time(s) | Optimal |
|---|---|---|---|
| B | Without IUB | With IUB | Obj Value |
| 0 | 0.1 | 0.2 | 8 |
| 1 | 0.9 | 0.3 | 9 |
| 2 | 6.5 | 0.4 | 10 |
| 3 | 41.5 | 1.9 | 11 |
| 4 | 414.0 | 13.0 | 11 |
| 5 | >1000 | 25.0 | 12 |

TABLE 2
Results for Pure Integer Approach

| | Opt Obj of | Time(s) of | Opt Obj of | Time(s) of |
|---|---|---|---|---|
| B | Instance 1 | Instance 1 | Instance 2 | Instance 2 |
| 0 | 88 | 0.3 | 86 | 0.3 |
| 1 | 89 | 0.3 | 87 | 0.6 |
| 2 | 90 | 0.3 | 88 | 0.7 |
| 3 | 91 | 3.0 | 89 | 0.7 |
| 4 | 92 | 3.6 | 90 | 6.0 |
| 5 | 93 | 5.9 | 91 | 3.8 |
| 6 | 94 | 5.7 | 92 | 9.3 |
| 7 | 95 | 3.1 | 93 | 24.7 |
| 8 | 96 | 48.3 | 94 | 6.4 |
| 9 | 97 | 6.8 | 95 | 16.7 |
| 10 | 98 | 5.3 | 96 | 6.5 |

Table 3 shows results of the mixed-integer approach. The method started from the initial interdiction with no edge attacked, i.e., yₑ=0, ∀eεE. The results for the small size problem (30 vertices and 50 edges) are shown in Table 3, which are actually better than the pure integer approach.

TABLE 3
Results for Mixed-Integer Approach

| | | Optimal | |
|---|---|---|---|
| B | Time(s) | Obj Value | Iteration |
| 0 | 0.25 | 8 | 2 |
| 1 | 0.34 | 9 | 2 |
| 2 | 2.15 | 10 | 10 |
| 3 | 2.52 | 11 | 11 |
| 4 | 1.9 | 11 | 7 |
| 5 | 3.83 | 12 | 11 |

### Example 3

Multi-start Benders Decomposition (MSBD) is a common existing method for solving power system interdiction problems (see, e.g., Delgadillo, Arroyo, and Alguacil in IEEE Power Systems, 2010). This method was compared to a C&CG algorithm according to an embodiment of the subject invention. The C&CG algorithm was as follows:
Step 1. Set LB=−∞, UB=+∞, h=0, U=, and an optimality tolerance ε.
Step 2. Solve the partial single-level formulation I (or II) (as the master problem). Derive an optimal solution (y*^{h}, η*^{h}) and update LB=η*^{h}.
Step 3. Solve the lower level problem ^{max}(z,x)|y*^{h} (as the sub-problem) and update upper bound=min{UB, opt(y*^{h})}.
Step 4. If UB−LB≦ε, return y*^{h} as an optimal solution and terminate. Otherwise, update U=U∪{h}, create new continuous recourse decision variables x^{h} corresponding to the obtained z^{h} (parameter obtained in step 3), update h=h+1, and go to step 2.

The methods were tested on a problem of an IEEE one-area RTS-96 system, having 24 buses and 38 transmission lines. The available computing facilities for each method are shown in Table 4. The global optimality tolerance for C&CG is 1×10⁻⁴.

TABLE 4
Computing facilities

| | MSBD | |
|---|---|---|
| Platform | (Delgadillo et al. 2010) | C&CG |
| CPU | 4 processors at 2.6 GHz | 1 processor 3 GHz |
| RAM | 32 G | 3.25 G |
| CPLEX | 11.0.1 | 12.4 |
| Global Opt. Tolerance ε | NA | 1 × 10⁻⁴ |
| ε for Master/Sub-Problem | 1× 10⁻² | 1 × 10⁻⁴ |

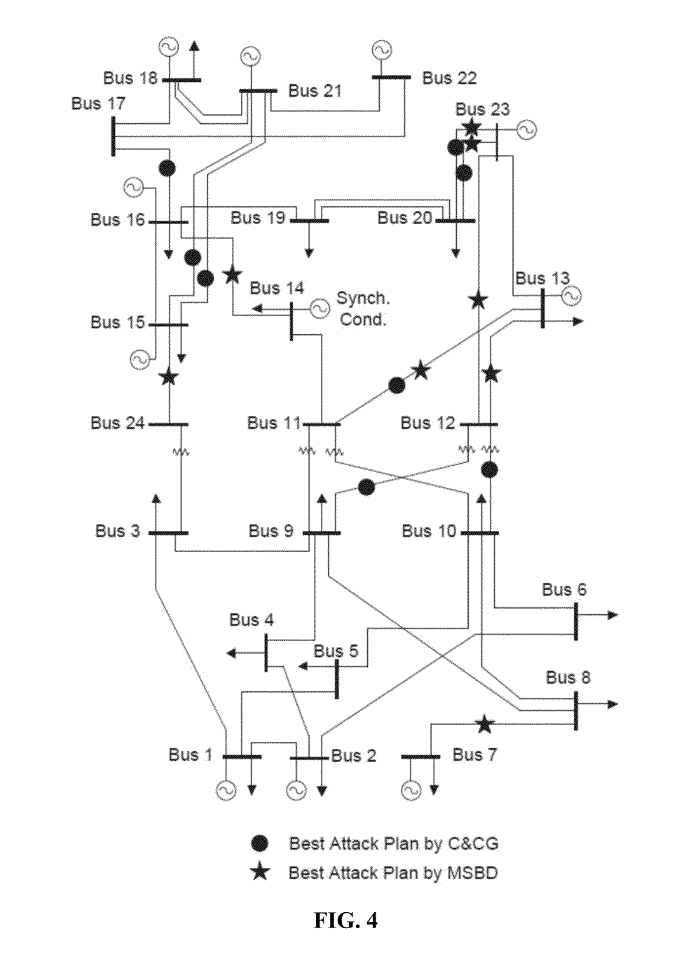

Table 5 shows a comparison of the performance of the C&CG method according to an embodiment of the subject invention and the MSBD method. The average computing time for the C&CG method was only 1.8% of that for the MSBD method, and the solution quality was unknown for several instances of the MSBD method (indicated in Table 5 by asterisks). Table 6 shows the load shedding caused by attacks for the C&CG method according to an embodiment of the subject invention and the MSBD method. The asterisks in Table 6 indicate that the solution of the MSBD method is not the global optimal. FIG. 4 shows a schematic of the IEEE one-area RTS-96 system, with the best attack denoted for each method.

TABLE 5
Algorithm Performance Comparison

| | Time (s) of | Time (s) of | Iterations |
|---|---|---|---|
| K | MSBD | C&CG | of C&CG |
| 1 | 18.48 | 23.48 | 7 |
| 2 | 293.31* | 22.01 | 6 |
| 3 | 2261.59* | 20.51 | 6 |
| 4 | 2180.67* | 19.42 | 4 |
| 5 | 1610.35* | 17.92 | 2 |
| 6 | 1520.47* | 17.04 | 2 |
| 7 | 0.89 | 16.24 | 1 |
| 8 | 1312.42* | 15.65 | 3 |
| 9 | 1155.64* | 14.77 | 2 |
| 10 | 1029.01* | 14.28 | 2 |
| 11 | 0.85 | 13.48 | 1 |
| 12 | 0.88 | 12.85 | 1 |
| Average | 948.71 | 17.30 | |
| Time | | | |

*indicating the solution quality is unknown in MSBD.
When K = 10, there are (₁₀³⁸) ≧ 400 million possible attacks and 2³⁸ ≧ 200 billion possible line switching decisions.

TABLE 6
Load Shedding Caused by Attacks

| K | MSBD | C&CG |
|---|---|---|
| 1 | 131 | 131 |
| 2 | 279 | 279 |
| 3 | 429 | 429 |
| 4 | 538 | 538 |
| 5 | 688 | 688 |
| 6 | 775 | 775 |
| 7 | 855 | 855 |
| 8* | 905* | 915* |
| 9 | 1002 | 1002 |
| 10* | 1017* | 1051* |
| 11 | 1131 | 1131 |
| 12 | 1194 | 1194 |

### Example 4

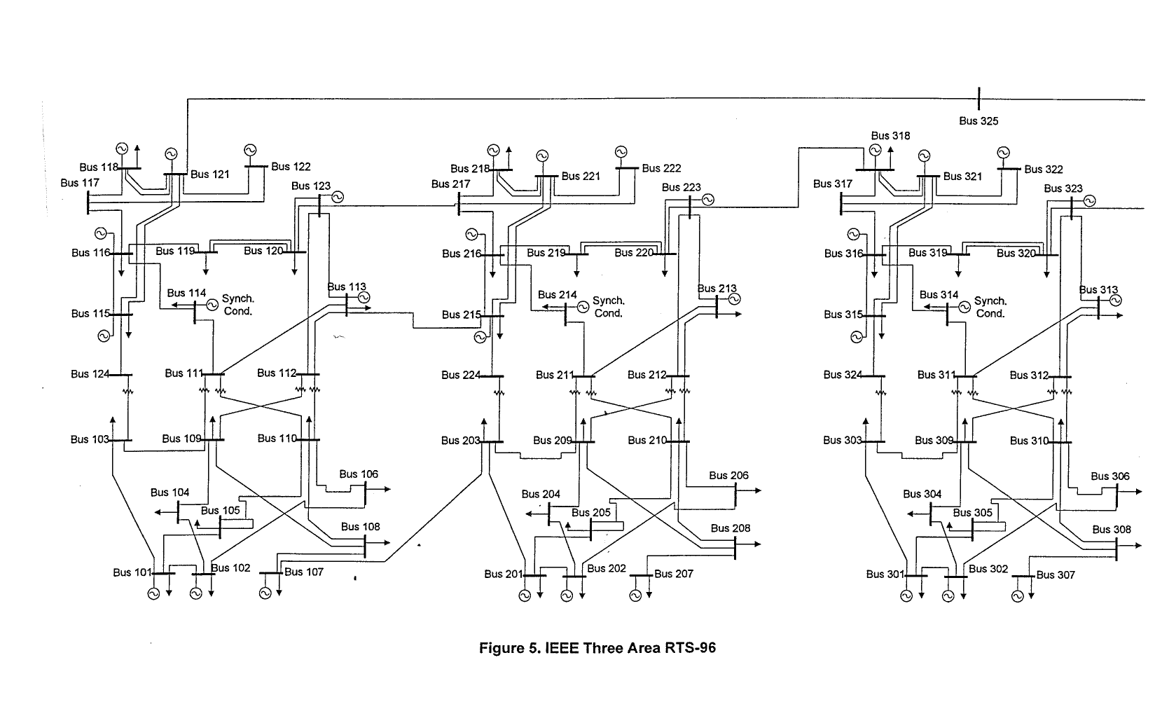

A C&CG algorithm according to an embodiment of the subject invention was tested on a problem of an IEEE three-area RTS-96 system, having 73 buses and 120 transmission lines. The C&CG algorithm was as in Example 3. A schematic of the IEEE three-area RTS-96 system is shown in FIG. 5. Five interconnecting transmission lines merge three single areas—three lines between the first two areas, one line joining the second and the third area, and one transmission line connecting the first and third areas. Table 7 shows the results of the interdiction problem. When K≧7, the computational expense is huge, and memory becomes a bottleneck. Five inter-area lines generally switch off under interdictions. Hence, islanding is a powerful tool to mitigate transmission line loss.

TABLE 7
Results of IEEE Three-Area RTS-96 System Interdiction

| | Load Shedding | Computational |
|---|---|---|
| K | (MW) | Time (s) |
| 1 | 131 | 16.18 |
| 2 | 279 | 36.72 |
| 3 | 429 | 91.13 |
| 4 | 559 | 151.91 |
| 5 | 707 | 179.2 |
| 6 | 857 | 215.2 |

### Example 5

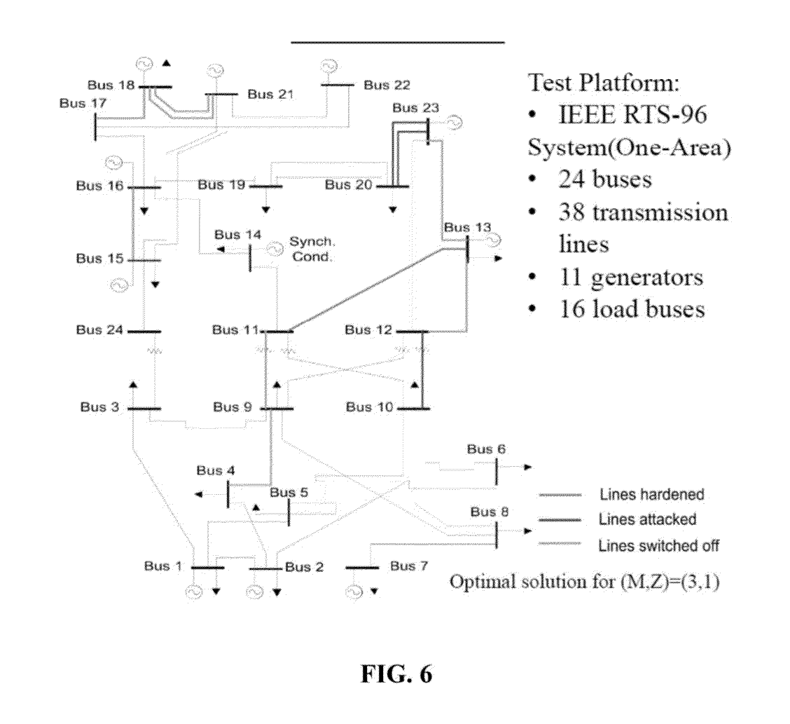

A nested C&CG (NCCG) algorithm according to an embodiment of the subject invention was tested on a problem of an IEEE one-area RTS-96 system, having 24 buses, 38 transmission lines, 11 generators, and 16 load buses. A schematic of the IEEE one-area RTS-96 system is shown in FIG. 6. The algorithm was implemented in C++ with CPLEX 12.4 on a PC with an Intel Core© 2Duo 3.00 GHz CPU and 4 GB RAM. The tolerable gap was set as 1%. The optimal solution was found to be (M, Z)=(3, 1). FIG. 7 shows a flow chart of the algorithm used. In addition, the NCCG master problem and sub-problem are shown below.

NCCG Master Problem:

$$s . t . α \geq {\sum }_{n} {d}_{n}^{i} , ∀ i = 1 , … , k$$

$${p}_{l}^{i} {x}_{l} = {w}_{l}^{i} ( {z}_{l} + {\hat{v}}_{l}^{i} - {z}_{l} {\hat{v}}_{l}^{i} ) [ {δ}_{o ( l )}^{i} - {δ}_{d ( l )}^{i} ] , ∀ l , i = 1 , … , k$$

$${\sum }_{j ∈ Jn} {g}_{j}^{i} - {\sum }_{l \vert o ( l ) = n} {p}_{l}^{i} + {\sum }_{l \vert d ( l ) = n} {p}_{l}^{i} + {d}_{n}^{i} = {D}_{n} , ∀ n , ∀ i = 1 , … , k \\ - {p}_{l}^{max} \leq {p}_{l}^{i} \leq {p}_{l}^{max} , ∀ l , ∀ i = 1 , … , k$$

$$0 \leq {g}_{j}^{i} \leq {p}_{j}^{max} , ∀ j , ∀ i = 1 , … , k \\ - {δ}^{max} \leq {δ}_{n}^{i} \leq {δ}^{max} , ∀ n , ∀ i = 1 , … , k$$

$$0 \leq {d}_{n}^{i} \leq {D}_{n} , ∀ n , ∀ i = 1 , … , k$$

$${w}_{l}^{i} , {z}_{l} ∈ \{ 0 , 1 \}$$

NCCG Sub-Problem:

$${max}_{v ∈ V} {min}_{w ∈ W} {\sum }_{n ∈ N} {d}_{n}$$

$$s . t . {p}_{l} {x}_{l} - {w}_{l} ( {\hat{z}}_{l} + {v}_{l} - {\hat{z}}_{l} {v}_{l} ) [ {δ}_{o ( l )} - {δ}_{d ( l )} ] , = 0 , ∀ l$$

$${\sum }_{j ∈ Jn} {g}_{j} - {\sum }_{l \vert o ( l ) = n} {p}_{l} + {\sum }_{l \vert d ( l ) = n} {p}_{l} + {d}_{n} = {D}_{n} , ∀ n \\ - {p}_{l}^{max} \leq {p}_{l} \leq {p}_{l}^{max} , ∀ l$$

$$0 \leq {g}_{j} \leq {g}_{j}^{max} , ∀ j \\ - {δ}^{max} \leq {δ}_{n} \leq {δ}^{max} , ∀ n$$

$$0 \leq {d}_{n} \leq {D}_{n} , ∀ n$$

$${v}_{l} , {w}_{l} ∈ \{ 0 , 1 \}$$

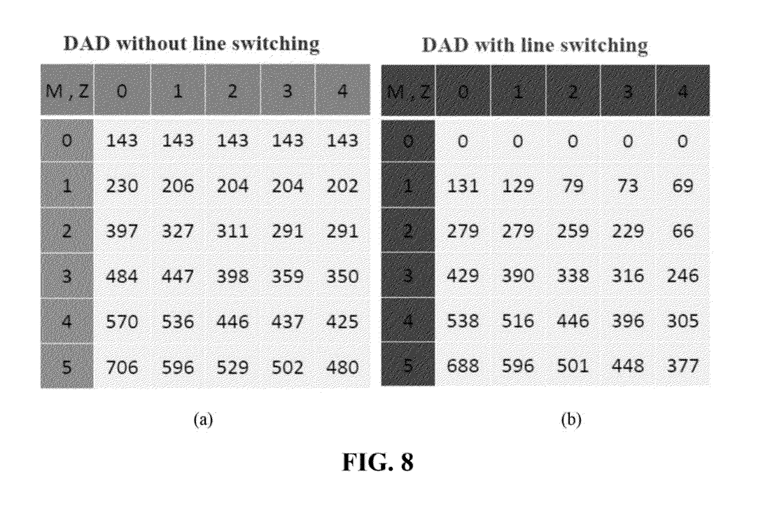

A case study was done on a comparison between a defend-attack-defend model (DAD) without line switching and DAD with line switching. FIG. 8 shows load sheds (MW) of the system at various values of (M, Z) for the DAD without line switching (FIG. 8A) and the DAD with load switching (FIG. 8B). The attack budget (M) was 0-5, and the hardening budget (Z) was 0-4.

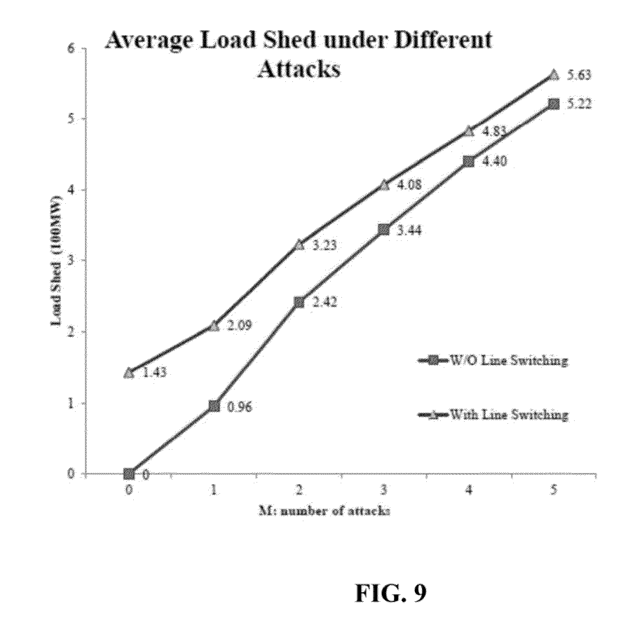

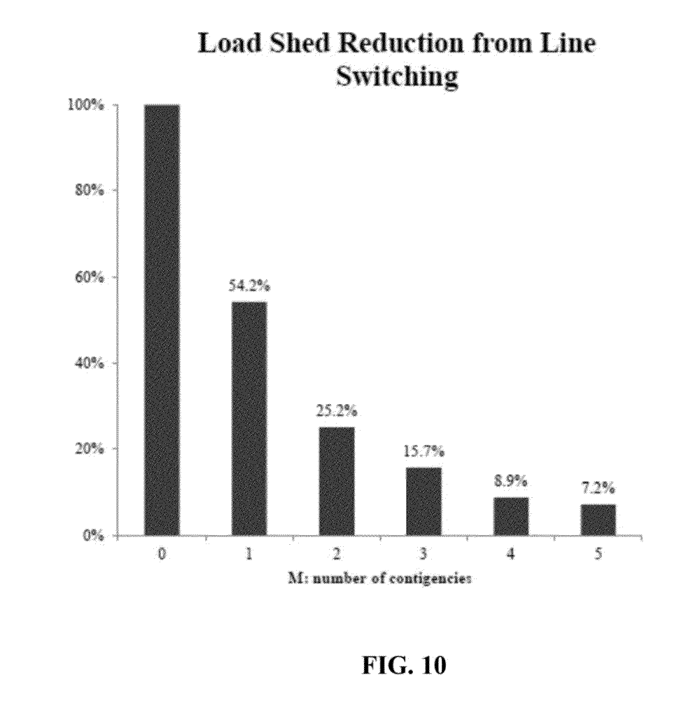

FIG. 9 shows the average load shed under different attacks (e.g., contingencies), and FIG. 10 shows the load shed reductions in percentages. An average of 22.8% of costs in terms of load shed could be reduced by introducing line switching into DAD models. Thus, the benefit of introducing line switching is substantial.

### Example 6

A C&CG algorithm according to an embodiment of the subject invention was tested on a problem using C++ on a PC desktop for implementation, and the commercial solver IBM ILOG CPLEX 12.4 was used as the MIP solver with ε=1×10⁻⁴. One possible strategy, which can accelerate the computational speed, is to start from the master problem with respect to the full topology of the power network, i.e., z-hat=1, in the first iteration.

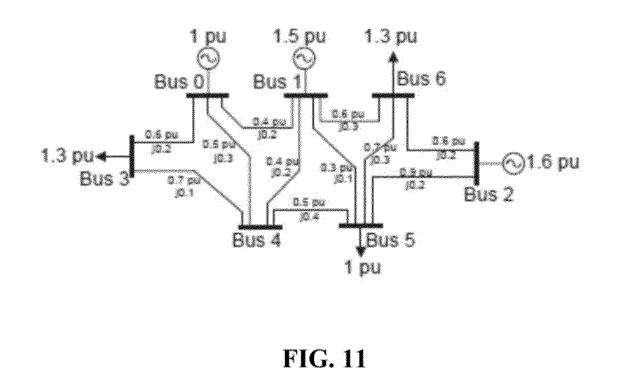

A C&CG algorithm according to an embodiment of the subject invention was tested on a problem of a simple 7-bus system whose topology and parameters are shown in FIG. 11. Table 8 presents the maximal load shedding with and without line switching operations, which show that the system can benefit from line switching to satisfy custom demand. All possible attacks were also enumerated, and the results were compared with the results using C&CG; these results are presented in Table 9. The maximal load shedding provided by enumeration is identical to that by C&CG, so it is omitted. Table 9 not only confirms the correctness of the proposed algorithm from an empirical point of view, but also shows that C&CG is more efficient as it only involves a few iterations (attack scenarios) to obtain a global optimal solution.

The C&CG algorithm was as follows:
Step 1. Set LB=−∞, UB=+∞, h=0, U=, and an optimality tolerance E.
Step 2. Solve the partial single-level formulation defined above as the master problem formulation (as the master problem). Derive an optimal solution (w*^{h}, η*^{h}, λ*^{h}) and update LB=η*^{h}.
Step 3. Solve the lower level problem defined above as the subproblem formulation (as the sub-problem) with w-hat=w*^{h} and update upper bound=min{UB, cy*}, where y*, including the optimal line switching z*, is the optimal solution of the lower level problem.
Step 4. If UB−LB≦ε, return w*^{h} as an optimal attack plan and terminate. Otherwise, update U=U∪{h} with z-hat^{(h)}−z*, create new recourse decision variables λ^{(h)}, and add the corresponding constraints defined in the second line of the master problem formulation defined above to go to the partial single level problem. Let h=h+1, and go to Step 2.

TABLE 8
Load Shedding on a 7-Bus System With and Without Line Switching

| | Load Shedding with | Load Shedding without |
|---|---|---|
| K | Line Switching (MW) | Line Switching (MW) |
| 1 | 90 | 131 |
| 2 | 150 | 189 |
| 3 | 210 | 222 |
| 4 | 260 | 264 |
| 5 | 290 | 320 |

TABLE 9
C&CG Versus Enumeration on a 7-Bus System With Line Switching

| | | | | Number |
|---|---|---|---|---|
| | | | | of |
| | Iteration of | Time (s) of | Time (s) of | Possible |
| K | C&CG | C&CG | Enumeration | Attacks |
| 1 | 4 | 1.34 | 1.75 | 11 |
| 2 | 7 | 2.64 | 7.11 | 55 |
| 3 | 4 | 1.40 | 18.86 | 165 |
| 4 | 5 | 1.64 | 34.92 | 330 |
| 5 | 3 | 0.84 | 47.83 | 462 |

### Example 7

A C&CG algorithm according to an embodiment of the subject invention was tested on a problem of an IEEE 118-bus system and was compared with the enumeration of all possible attacks. The network has 185 lines, 19 generation buses, and a total peak load of 4519 MW. The result of C&CG agrees with enumeration, and is much more efficient as shown in Table 10. The computer equipment and the algorithm were as presented in Example 6.

TABLE 10
Results of IEEE 118-Bus System

| | Maximum | | | |
|---|---|---|---|---|
| | Load | Iterations | Computational | Computational |
| | Shedding | of | Time (s) of | Time (s) of |
| K | (MW) | C&CG | C&CG | Enumeration |
| 1 | 190 | 2 | 10.01 | 104.02 |
| 2 | 44 | 1 | 20.54 | 20571.66 |

### Example 8

A C&CG algorithm according to an embodiment of the subject invention was tested on a problem of an IEEE three-area RTS-96 system, having 73 buses and 185 transmission lines. The C&CG algorithm was as in Example 6. Five interconnecting transmission lines merge three single areas—three lines between the first two areas, one line joining the second and the third area, and one transmission line connecting the first and third areas.

The master problem is used as a starting point, with all five inter-areas lines switched off at the beginning, i.e., z-hatᵢ=0, if line l is one of the five lines, namely, the restricted master problem. Therefore, the restricted initial master problem can be decomposed into three small attack-defend problems that are solved to optimality as in Example 3.

Formally, let w̅₁, w̅₂, and w̅₃ε [symbol] ₊ denote the number of lines attacked in each single area (call w̅₁ as “w-bar”, w̅₁ as “w-bar₁”, etc. in text), and let LoadS(w-bar) be a function defined from the number of attacked lines to the maximum load shedding in a single area obtained in Example 3. For example, LoadS(1)=131, LoadS(2)=279, etc. Then, the maximum load shedding corresponding to the restricted master problem is equivalent to the optimal objective value of the following “knapsack” problem:

max LoadS( w̅₁)+LoadS( w̅₂)+LoadS( w̅₃)

st. w̅₁+ w̅₂+ w̅₃≦K,

w̅₁, w̅₂, w̅₃ε [symbol] ₊,

The proof is as follows:

Proof. Let I_{b}^{A}, I_{b}^{B}, and I_{b}^{C} denote the collection of buses in each of the three areas, respectively, with I_{b}³=I_{b}^{A}∪I_{b}^{B}∪I_{b}^{C}. Similarly, let Iₗ^{A}, Iₗ^{B}, and Iₗ^{C} denote the collection of transmission lines in each of the three areas, respectively, with Iₗ³=Iₗ^{A}∪Iₗ^{B}∪Iₗ^{C}. Let Iₚ denote the set of lines. The master problem is

$$\begin{matrix}{min}_{w ∈ {𝒜}^{′}} {max}_{\{ p , d , f , θ , z \}} {\sum }_{j ∈ {I}_{b}^{3}} {d}_{j}^{n} & ( 49 ) \\ s . t . {z}_{l} {w}_{l} ( {θ}_{m} - {θ}_{n} - {x}_{l} {f}_{l}^{mn} ) = 0 , ∀ l ∈ {I}_{l}^{3} ⋃ {I}_{p} & ( 50 ) \\ - {F}_{l} {z}_{l} {w}_{l} \leq {f}_{l}^{mn} \leq {z}_{l} {w}_{l} {F}_{l} , ∀ l ∈ {I}_{l}^{3} ⋃ {I}_{p} & ( 51 ) \\ {p}_{i}^{n} \leq {P}_{i}^{max} , ∀ i ∈ {I}_{b}^{3} & ( 52 ) \\ {d}_{j}^{n} \leq {D}_{j}^{n} , ∀ j ∈ {I}_{b}^{3} & ( 53 ) \\ {\sum }_{l} {f}_{l}^{. n} + {p}_{i}^{n} = {\sum }_{l} {f}_{l}^{n .} + {d}_{j}^{n} , ∀ n ∈ {I}_{b}^{3} & ( 54 ) \\ {p}_{i}^{n} \geq 0 , {d}_{j}^{n} \geq 0 , {f}_{l}^{mn} , {θ}_{n} free , {z}_{l} ∈ \{ 0 , 1 \} & ( 55 )\end{matrix}$$

where A′={wε [symbol] |Iₗ³|+|Iₚ|:wₗε{0, 1}, τₗ(1−wₗ)≦K}.

Clearly, the optimal objective value of the restricted master problem defined in (49)-(55) with parameters zₗ=0, ∀lεIₚ in the lower level, is a lower bound of the virtual master problem, i.e., the one defined with variables zₗε{0, 1}, ∀lεIₚ. The maximum load shedding is

$${\sum }_{j ∈ {I}_{b}^{3}} {D}_{j}^{n} - {min}_{w ∈ {𝒜}^{′}} {max}_{\{ p , d , f , θ , z \} ∈ ( 50 ) - ( 55 )} {\sum }_{j ∈ {I}_{b}^{3}} {d}_{j}^{n} , \\ which is equivalent to$$

$${max}_{w ∈ {𝒜}^{′}} {min}_{\{ p , d , f , θ , z \} ∈ ( 50 ) - ( 55 )} {\sum }_{j ∈ {I}_{b}^{3}} {D}_{j}^{n} - {\sum }_{j ∈ {I}_{b}^{3}} {d}_{j}^{n} .$$

Noting that the three areas are isolated in the restricted master problem, i.e., zₗ=0, ∀lεIₚ, the lower level can be decomposed into three independent problems. By applying w̅₁=Σ_{lεI}_{ₗ}_{^{A}}(1−wₗ), w̅₂=Σ_{lεI}_{ₗ}_{^{B}}(1−wₗ), and w̅₃=Σ_{lεI}_{ₗ}_{^{C}}(1−wₗ), it follows from the definition of LoadS( w̅) in Subsection IV-C that the maximum load shedding corresponding to the restricted master problem is equivalent to the optimal objective value of the “knapsack” problem defined above.

For example, if the optimal solution to the above problem is w-hat₁−1, w-hat₂−2, w-hat₃−1 for K=4, the maximal load shedding is 131+279+131 (MW) and the optimal attack corresponds to K=1, K=2, and K=1 for each single area, respectively. Then the algorithm continues with the subproblem, and the global optimality can be obtained when lower and upper bounds match.

Interestingly, for all instances with K≦6, numerical results show that an optimal attack does not remove inter-area lines and actually those lines are switched off defensively by an optimal system operator, as shown in Table 10. Hence, a clear islanding phenomenon is observed here. One of the reasons may be that each single area is balanced in generation and load, i.e., the power generation can successfully satisfy the demand. This feature is related to when a sub-area is generation rich but another is demand rich and the attacker will tend to remove the inter-areas lines.

The strategy presented here in Example 8 can be used in a system with different subsystems, in which case multiple functions LoadS_{ξ}(•), ξ=1, 2, . . . , will be defined instead of a single one. Therefore, it provides an idea to address a large-scale network problem given that its sub-area problems can be solved efficiently.

TABLE 10
Results of the IEEE Three-Area RTS-96 System Interdiction

| | Maximal Load | Computational |
|---|---|---|
| K | Shedding (MW) | Time (s) |
| 1 | 131 + 0 + 0 | 0.56 |
| 2 | 279 + 0 + 0 | 0.36 |
| 3 | 429 + 0 + 0 | 0.47 |
| 4 | 131 + 429 + 0 | 0.46 |
| 5 | 279 + 429 + 0 | 0.32 |
| 6 | 429 + 429 + 0 | 0.39 |

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A system for solving an interdiction problem, comprising:
one or more computer-readable storage media having an algorithm for solving the interdiction problem embodied in program instructions stored thereon,
wherein, when executed by a processing system, the program instructions direct the processing system to perform the algorithm,
wherein the algorithm comprises the steps of:
(a) picking up an arbitrary y¹εY, and setting η=0 and k=1;
(b) solving a minimum dominating set (MDS) problem for the given y^{k}, denoting the solution by x^{k}. If ∥x^{k}∥₁>η and updating y*=y^{k} and η=∥x^{k∥}₁;
(c) determining if there exists an infeasible edge interdiction, and if so, setting w⊂Y of {Dⁿ}ₙ₌₁^{k} in G, where Dⁿ=V(xⁿ), letting k=k+1, y^{k}=w and going to step (b); if no infeasible edge interdiction exists, stopping the algorithm and determining that the solution is obtained.

2. The system according to claim 1, wherein set w in iteration k is any feasible solution to system P can be the desired set w in iteration k, and no such a w exists if the system is unsolvable, wherein system P is as follows:
$$P = \{ \begin{matrix}{\sum }_{( {v}_{i} , {v}_{j} ) ∈ E} {c}_{ij} {y}_{ij} \leq B , \\ {\sum }_{u ∈ {\overline{D}}_{q}} {\prod }_{e ∈ {F}_{u} ( {d}_{q} )} {y}_{e} \geq 1 , ∀ q = 1 , 2 , … , k \\ {y}_{e} ∈ \{ 0 , 1 \} , ∀ e ∈ E .\end{matrix} \}$$

3. The system according to claim 1, wherein a lower bound is any feasible attack, and wherein an upper bound is as follows:
r(G)+L=max{Σ₍ᵥ_{ᵢ}_{,v}_{ⱼ}_{)εE}yᵢⱼ:Σ₍ᵥ_{ᵢ}_{,v}_{ⱼ}_{)εE}cᵢⱼyᵢⱼ≦B,yᵢⱼε{0,1},∀(vᵢ,vⱼ)εE}.

4. The system according to claim 1, wherein, if system P′ is unsolvable, then an upper bound of the MDS problem is max {γ(G)+T−1, max {∥x^{1∥}₁, ∥x^{2∥}₁, . . . , ∥x^{m}∥₁}}, wherein system P′ is as follows:
$${P}^{′} = \{ \begin{matrix}{\sum }_{u ∈ \overline{D} 0} {\prod }_{e ∈ {F}_{u} ( {D}_{0} )} {y}_{e} \geq T \\ {\sum }_{( {v}_{i} , {v}_{j} ) ∈ E} {c}_{ij} {y}_{ij} \leq B , \\ {\sum }_{u ∈ {\overline{D}}_{q}} {\prod }_{e ∈ {F}_{u} ( {D}_{q} )} {y}_{e} \geq 1 , ∀ q = 1 , 2 , … , m \\ {y}_{e} ∈ \{ 0 , 1 \} , ∀ e ∈ E ,\end{matrix} \}$$

5. The system according to claim 1, wherein discrete variables are separated from a mixed integer decision set of a lower-level problem of the algorithm.

6. The system according to claim 1, wherein, if the lower-level problem includes only integer variables, an equivalent mixed-integer decision set of a lower-level problem of the algorithm is generated.

7. The system according to claim 1, wherein, when executed by a processing system, the program instructions direct the processing system to identify a subset of network components of a network, the removal of which leads to improved performance of the network, wherein identification of the subset of network components is performed by performing the algorithm.

8. The system according to claim 6, wherein the subset of network components comprises at least one of flow volume, traveling distance, and size.

9. The system according to claim 1, wherein the interdiction problem is an attack-defend problem, a tri-level mixed-integer defend-attack-defend problem, a pure discrete defend problem, or a tri-level optimization problem with a mixed-integer recourse problem. The overall load shedding in contingencies can be minimized.

10. A system for solving an interdiction problem, comprising:
one or more computer-readable storage media having an algorithm for solving the interdiction problem embodied in program instructions stored thereon,
wherein, when executed by a processing system, the program instructions direct the processing system to perform the algorithm,
wherein the algorithm comprises the steps of:
(a) setting LB=−∞, UB=+∞, h=0, U=, and an optimality tolerance ε;
(b) solving a partial single-level formulation, deriving an optimal solution (y*^{h}, η*^{h}), and updating LB=η*^{h};
(c) solving a lower level problem ^{max}(z,x)|y*^{h} and updating an upper bound=min{UB, opt(y*^{h})};
(d) determining if UB−LB≦ε, and, if so, returning y*^{h} as an optimal solution and stopping the algorithm; if UB−LB>ε, updating U=U∪{h} and h=h+1, creating new continuous recourse decision variables, and going to step (b).

11. The system according to claim 10, wherein creating new continuous recourse decision variables in step (d) comprises creating new continuous recourse decision variables (π^{h}) corresponding to the obtained z^{h}.

12. The system according to claim 10, wherein creating new continuous recourse decision variables in step (d) comprises creating new continuous recourse decision variables (π^{h}) to the partial single-level problem.

13. The system according to claim 10, wherein the partial single-level formulation is one of the following formulations:
$${min}_{y ∈ Y} {max}_{( z , x ) ∈ {Z}_{+}^{{n}_{1}}} {c}_{1} z + {max}_{x ∈ {R}_{+}^{{n}_{2}} \text{:} {A}_{2} x \leq b - hy - {A}_{1} z} {c}_{2} x$$
$$or$$
$${min}_{y ∈ Y} {max}_{( z , x ) ∈ {Z}_{+}^{{n}_{1}}} {c}_{1} z + {min}_{π ∈ {R}_{+}^{m} \text{:} {A}_{2}^{′} π \geq {c}_{2}} {( b - hy - {A}_{1} z )}^{′} π .$$

14. The system according to claim 13, wherein creating new continuous recourse decision variables in step (d) comprises creating new continuous recourse decision variables (x^{h}) or (π^{h}) corresponding to the obtained z^{h}.

15. The system according to claim 13, wherein creating new continuous recourse decision variables in step (d) comprises creating new continuous recourse decision variables (x^{h}) or (π^{h}) to the partial single-level problem.

16. The system according to claim 8, wherein the interdiction problem is an attack-defend problem, a tri-level mixed-integer defend-attack-defend problem, a pure discrete defend problem, or a tri-level optimization problem with a mixed-integer recourse problem. The overall load shedding in contingencies can be minimized.

17. A system for solving an interdiction problem, comprising:
one or more computer-readable storage media having an algorithm for solving the interdiction problem embodied in program instructions stored thereon,
wherein, when executed by a processing system, the program instructions direct the processing system to perform the algorithm,
wherein the algorithm comprises the steps of:
(a) setting LB=−∞, UB=+∞, h=0, U=, and an optimality tolerance c;
(b) Solving a partial single-level formulation, deriving an optimal solution (w*^{h}, η*^{h}, λ*^{h}), and updating LB=η*^{h};
(c) solving a lower level problem with w-hat=w*^{h} and updating upper bound=min{UB, cy*}, where y*, including the optimal line switching z*, is the optimal solution of the lower level problem;
(d) determining if UB−LB≦ε, and, if so, returning w*^{h} as an optimal attack plan and stopping the algorithm; if UB−LB>ε, updating U=U∪{h} with z-hat^{(h)}−z*, creating new recourse decision variables λ^{(h)}, adding additional constraints to go to a partial single level problem, updating h=h+1, and going to step (b).

18. The system according to claim 17, wherein the partial single-level formulation is as follows:
$$min α$$
$$s . t . α \geq {\sum }_{n} {d}_{n}^{i} , ∀ i = 1 , … , k$$
$${p}_{l}^{i} {x}_{l} = {w}_{l}^{i} ( {z}_{l} + {\hat{v}}_{l}^{i} - {z}_{l} {\hat{v}}_{l}^{i} ) [ {δ}_{o ( l )}^{i} - {δ}_{d ( l )}^{i} ] , ∀ l , i = 1 , … , k$$
$${\sum }_{j ∈ Jn} {g}_{j}^{i} - {\sum }_{l \vert o ( l ) = n} {p}_{l}^{i} + {\sum }_{l \vert d ( l ) = n} {p}_{l}^{i} + {d}_{n}^{i} = {D}_{n} , ∀ n , ∀ i = 1 , … , k \\ - {p}_{l}^{max} \leq {p}_{l}^{i} \leq {p}_{l}^{max} , ∀ l , ∀ i = 1 , … , k$$
$$0 \leq {g}_{j}^{i} \leq {p}_{j}^{max} , ∀ j , ∀ i = 1 , … , k \\ - {δ}^{max} \leq {δ}_{n}^{i} \leq {δ}^{max} , ∀ n , ∀ i = 1 , … , k$$
$$0 \leq {d}_{n}^{i} \leq {D}_{n} , ∀ n , ∀ i = 1 , … , k$$
$${w}_{l}^{i} , {z}_{l} ∈ \{ 0 , 1 \}$$

19. The system according to claim 18, wherein the lower level problem is as follows:
$${max}_{v ∈ V} {min}_{w ∈ W} {\sum }_{n ∈ N} {d}_{n}$$
$$s . t . {p}_{l} {x}_{l} - {w}_{l} ( {\hat{z}}_{l} + {v}_{l} - {\hat{z}}_{l} {v}_{l} ) [ {δ}_{o ( l )} - {δ}_{d ( l )} ] = 0 , ∀ l$$
$${\sum }_{j ∈ Jn} {g}_{j} - {\sum }_{l \vert o ( l ) = n} {p}_{l} + {\sum }_{l \vert d ( l ) = n} {p}_{l} + {d}_{n} = {D}_{n} , ∀ n \\ - {p}^{max} \leq {p}_{l} \leq {p}_{l}^{max} , ∀ l$$
$$0 \leq {g}_{j} \leq {g}_{j}^{max} , ∀ j \\ - {δ}^{max} \leq {δ}_{n} \leq {δ}^{max} , ∀ n$$
$$0 \leq {d}_{n} \leq {D}_{n} , ∀ n$$
$${v}_{l} , {w}_{l} ∈ \{ 0 , 1 \} .$$

20. The system according to claim 18, wherein adding additional constraints to go to a partial single level problem in step (d) comprises adding the constraints defined in the second line of the partial single-level formulation.
